(19) United States
(12) Patent Application Publication
(10) Pub. No.: US 2023/0403753 A1
(43) Pub. Date: Dec. 14, 2023

(54) MULTI-LINK OPERATION (MLO) IN A MESH NETWORK

(71) Applicant: QUALCOMM Incorporated, San Diego, CA (US)

(72) Inventors: Xiaolong HUANG, Santee, CA (US); Rajkumar VENKADASAMY MANOHARAN, Sunnyvale, CA (US); Abhishek Pramod PATIL, San Diego, CA (US); Sai Yiu Duncan HO, San Diego, CA (US); Vasanthakumar THIAGARAJAN, Chennai (IN)

(21) Appl. No.: 17/839,818

(22) Filed: Jun. 14, 2022

(51) Int. Cl. H04W 76/15; H04W 76/11

(52) U.S. Cl. CPC H04W 76/15; H04W 76/11; H04W 84/12

(57) ABSTRACT

This disclosure includes a multi-link device (MLD) transmitting a frame on a first communication link associated with a first device of the MLD, the frame carrying a plurality of addresses of a respective plurality of peer devices associated with a mesh basis service set (MBSS), each of the plurality of addresses associated with one of a per-link address of the first communication link of the MLD or a medium access control (MAC) address of the MLD. In some instances, the addresses include first and second addresses indicating respective receiver and transmitter addressees of a peering instance, and include third and fourth addresses indicating respective MBSS egress and MBSS ingress points of the peering instance. The first and second addresses are associated with the per-link address of the first communication link, and the third and fourth addresses are associated with the MLD MAC address.

### TECHNICAL FIELD

This disclosure relates generally to wireless communications, and more specifically, to enabling multi-link operation (MLO) in a mesh network.

### DESCRIPTION OF THE RELATED TECHNOLOGY

Wireless communications systems are widely deployed to provide various types of communication content such as voice, video, packet data, messaging, broadcast, and so on. A wireless local area network (WLAN) may be formed by one or more access points (APs) that provide a shared wireless communication medium for use by a number of client devices also referred to as stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

Mesh networks may be used in various environments including home entertainment systems, home automation, factory automation, and so on. In a mesh network, wireless devices operating as mesh nodes may be connected to one another in a non-hierarchical network topology via mesh links, and may cooperate with one another to efficiently route data from a source to a destination using one or more nodes and their corresponding mesh links. For example, intermediate mesh nodes that receive messages from upstream mesh nodes can broadcast or forward the messages to one or more downstream mesh nodes via corresponding mesh links until the messages reach the destination. In this way, mesh networks can extend the effective radio range of wireless devices that serve as mesh nodes in a mesh network.

The throughput of a mesh network may be based, at least in part, on the channel width of the mesh links interconnected between mesh nodes associated with the mesh network. Increasing the channel width of the mesh links may not be feasible, particularly in environments that include other wireless networks operating on the same or similar frequencies as the mesh network.

### SUMMARY

The systems, methods and devices of this disclosure each have several innovative aspects, no single one of which is solely responsible for the desirable attributes disclosed herein.

One innovative aspect of the subject matter described in this disclosure can be implemented in a multi-link device (MLD). The MLD can include a processing system and an interface coupled to the processing system. The interface may be configured to output a frame on a first communication link associated with a first device of the MLD, the frame including a medium access control (MAC) header carrying a plurality of addresses associated with a mesh basis service set (MBSS), each address of the plurality of addresses associated with one of a per-link address of the first communication link of the MLD or a MAC address of the MLD. In some implementations, the plurality of addresses may include first and second addresses indicating respective receiver and transmitter addresses of a peering instance on the first communication link, and may include third and fourth addresses indicating respective MBSS egress and MBSS ingress points of the peering instance on the first communication link. In some instances, the first and second addresses may be associated with the per-link address of the first communication link, and the third and fourth addresses may be associated with the MLD MAC address. In some other implementations, the plurality of addresses also may include fifth and sixth addresses indicating a destination and a source, respectively, of the peering instance, the fifth and sixth addresses associated with the MLD MAC address. In some aspects, the frame may include an indication that the per-link address is based on a domain of the first device of the MLD.

In some implementations, the frame may be one of a Hybrid Wireless Mesh Protocol (HWMP) Mesh Path Selection frame, a Mesh Peering Open frame, a Mesh Peering Confirm frame, a Mesh Peering Close frame, or a Mesh Data frame. In some instances, the frame may include a Multi-link element indicating discovery information for the first communication link of the MLD and discovery information for each of one or more second communication links associated with one or more respective second devices of the MLD. In some other instances, the frame may include a Traffic Identifier (TID)-to-Link Mapping (T2LM) element indicating, for each of a plurality of TIDs, on which of the first communication link or the one or more second communication links that mesh data frames belonging to the respective TID are permitted. In some aspects, the frame may include an Extremely High Throughput (EHT) Capability element indicating one or more capabilities of the first device of the MLD and one or more capabilities of each of the one or more second devices of the MLD. In some other aspects, the frame may include an EHT Operation element indicating one or more operation parameters for the first communication link of the MLD and one or more operation parameters for each of the one or more respective second communication links of the MLD.

In some implementations, the frame may be a Mesh Peering Open frame outputted over the first communication link to one or more candidate peer devices associated with the MBSS. The Mesh Peering Open frame may include a request to establish peering instances on each of the first communication link of the MLD and the one or more second communication links of the MLD. In some instances, the interface also may be configured to obtain a Mesh Peering Confirm frame on the first communication link from a respective candidate peer device, the Mesh Peering Confirm frame indicating whether the requested peering instance is accepted or rejected by the respective candidate peer device. The processing system also may be configured to associate with the candidate peer device on the first communication link of the MLD based on the Mesh Peering Open frame and the Mesh Peering Confirm frame.

In some other instances, the Mesh Peering Open frame may indicate MLD capabilities of the first device and the one or more second devices of the MLD. In some aspects, the interface may be configured to obtain a Mesh Peering Confirm frame on the first communication link from at least one candidate peer device including a respective station (STA) or access point (AP) associated with each of the first communication link of the MLD and the one or more second communication links of the MLD, the Mesh Peering Confirm frame indicating MLD capabilities of the respective STAs or APs of the at least one candidate peer device. The processing system may be configured to associate the first device of the MLD with a first STA or AP of the at least one candidate peer device on the first communication link responsive to the MLD capabilities of the at least one candidate peer device while associating the one or more second devices of the MLD with one or more respective second STAs or APs of the at least one candidate peer device on the one or more respective second communication links.

In some implementations, the interface also may be configured to obtain, from a peer MLD associated with the MBSS, a request for a Traffic Identifier (TID)-to-Link Mapping negotiation operation, a Target Wake Time (TWT) operation, or a restricted TWT (r-TWT) operation on a peering instance associated with the first communication link. In some instances, the processing system also may be configured to assign a Link Identifier (ID) to the requested operation. In various aspects, the assignment of the Link ID to the requested operation may be associated with one of the Link ID assigned to the peering instance by the MLD, the Link ID assigned to the peering instance by the peer MLD, or an agreement or negotiation between the MLD and the peer MLD indicating one of the Link ID assigned to the peering instance by the MLD or the Link ID assigned to the peering instance by the peer MLD.

Another innovative aspect of the subject matter described in this disclosure can be implemented as a method for wireless communication by an MLD. In some implementations, the method includes transmitting a frame on a first communication link associated with a first device of the MLD, the frame including a MAC header carrying a plurality of addresses associated with an MBSS, each address of the plurality of addresses associated with one of a per-link address of the first communication link of the MLD or a MAC address of the MLD. In some implementations, the plurality of addresses may include first and second addresses indicating respective receiver and transmitter addresses of a peering instance on the first communication link, and may include third and fourth addresses indicating respective MBSS egress and MBSS ingress points of the peering instance on the first communication link. In some instances, the first and second addresses may be associated with the per-link address of the first communication link, and the third and fourth addresses may be associated with the MLD MAC address. In some other implementations, the plurality of addresses also may include fifth and sixth addresses indicating a destination and a source, respectively, of the peering instance, the fifth and sixth addresses associated with the MLD MAC address. In some aspects, the frame may include an indication that the per-link address is based on a domain of the first device of the MLD.

In some implementations, the frame may be one of a HWMP Mesh Path Selection frame, a Mesh Peering Open frame, a Mesh Peering Confirm frame, a Mesh Peering Close frame, or a Mesh Data frame. In some instances, the frame may include a Multi-link element indicating discovery information for the first communication link of the MLD and discovery information for each of one or more second communication links associated with one or more respective second devices of the MLD. In some other instances, the frame may include a T2LM element indicating, for each of a plurality of TIDs, on which of the first communication link or the one or more second communication links that mesh data frames belonging to the respective TID are permitted. In some aspects, the frame may include an EHT Capability element indicating one or more capabilities of the first device of the MLD and one or more capabilities of each of the one or more second devices of the MLD. In some other aspects, the frame may include an EHT Operation element indicating one or more operation parameters for the first communication link of the MLD and one or more operation parameters for each of the one or more respective second communication links of the MLD.

In some implementations, the frame may be a Mesh Peering Open frame transmitted over the first communication link to one or more candidate peer devices associated with the MBSS. The Mesh Peering Open frame may include a request to establish peering instances on each of the first communication link of the MLD and the one or more second communication links of the MLD. In some instances, the method also may include obtaining a Mesh Peering Confirm frame on the first communication link from a respective candidate peer device, the Mesh Peering Confirm frame indicating whether the requested peering instance is accepted or rejected by the respective candidate peer device. The method also may include associating with the candidate peer device on the first communication link of the MLD based on the Mesh Peering Open frame and the Mesh Peering Confirm frame.

In some other instances, the Mesh Peering Open frame may indicate MLD capabilities of the first device and the one or more second devices of the MLD. In some aspects, the method also may include receiving a Mesh Peering Confirm frame on the first communication link from at least one candidate peer device including a respective STA or AP associated with each of the first communication link of the MLD and the one or more second communication links of the MLD, the Mesh Peering Confirm frame indicating MLD capabilities of the respective STAs or APs of the at least one candidate peer device. The method also may include associating the first device of the MLD with a first STA or AP of the at least one candidate peer device on the first communication link responsive to the MLD capabilities of the at least one candidate peer device while associating the one or more second devices of the MLD with one or more respective second STAs or APs of the at least one candidate peer device on the one or more respective second communication links.

In some implementations, the method also may include obtaining, from a peer MLD associated with the MBSS, a request for a TID-to-Link Mapping negotiation operation, a TWT operation, or an r-TWT operation on a peering instance associated with the first communication link. In some instances, the method also may include assigning a Link ID to the requested operation. In various aspects, the assignment of the Link ID to the requested operation may be associated with one of the Link ID assigned to the peering instance by the MLD, the Link ID assigned to the peering instance by the peer MLD, or an agreement or negotiation between the MLD and the peer MLD indicating one of the Link ID assigned to the peering instance by the MLD or the Link ID assigned to the peering instance by the peer MLD.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows an example system for wireless communications.

FIG. 2 shows a block diagram of an example path that may be established in a mesh network.

FIG. 3 shows a block diagram of another example path that may be established in a mesh network.

FIG. 4 shows a block diagram of another example path that may be established in a mesh network.

FIG. 5A shows an example protocol data unit (PDU) usable for communications between an access point (AP) and one or more wireless stations (STAs).

FIG. 5B shows an example field in the PDU of FIG. 4A.

FIG. 6 shows an example physical layer convergence protocol (PLCP) protocol data unit (PPDU) usable for communications between an AP and a number of STAs.

FIG. 7 shows a block diagram of an example wireless communication device.

FIG. 8A shows a block diagram of an example AP.

FIG. 8B shows a block diagram of an example STA.

FIG. 9 shows an example communication system that includes an AP multi-link device (MLD) and a non-AP MLD.

FIG. 10 shows an example multi-link mesh network including a plurality of peer MLDs and multi-link peering instances.

FIG. 11 shows example Medium Access Control (MAC) header address formats that may be used in a multi-link mesh network.

FIGS. 12-16 show flowcharts illustrating example operations for wireless communications that support multi-link operation in a mesh network.

FIG. 17A shows an example Multi-Link element usable for multi-link operation in a mesh network.

FIG. 17B shows an example Multi-Link Control field of a Multi-link element.

FIG. 17C shows an example Common Info field of a Multi-link element.

FIG. 17D shows an example MLD Capabilities field carried in the Common Info field of a Multi-link element.

FIG. 17E shows an example per-STA Profile subelement carried in the Link Info field of a Multi-link element.

FIG. 17F shows an example STA Control field carried in the per-STA Profile subelement of a Multi-link element.

FIG. 17G shows an example STA Info field carried in the per-STA Profile subelement of a Multi-link element.

FIG. 18 shows an example Traffic Identifier (TID)-to-Link Mapping element usable for multi-link operation in a mesh network.

FIG. 19A shows an example Reduced Neighbor Report (RNR) element that can be used to support multi-link operation in a mesh network.

FIG. 19B shows an example Target Beacon Transmission Time (TBTT) Information Header field carried in the TBTT Information Set field of an RNR element.

FIG. 19C shows an example TBTT Information field carried in the TBTT Information Set field of an RNR element.

FIG. 20 shows a block diagram of an example wireless communication device.

Like reference numbers and designations in the various drawings indicate like elements.

### DETAILED DESCRIPTION

The following description is directed to some particular implementations for the purposes of describing innovative aspects of this disclosure. However, a person having ordinary skill in the art will readily recognize that the teachings herein can be applied in a multitude of different ways. The described implementations can be implemented in any device, system or network that is capable of transmitting and receiving radio frequency (RF) signals according to one or more of the Long Term Evolution (LTE), 3G, 4G or 5G (New Radio (NR)) standards promulgated by the 3rd Generation Partnership Project (3GPP), the Institute of Electrical and Electronics Engineers (IEEE) 802.11 standards, the IEEE 802.15 standards, or the Bluetooth® standards as defined by the Bluetooth Special Interest Group (SIG), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF signals suitable for use in one or more of a wireless wide area network (WWAN), a wireless personal area network (WPAN), a wireless local area network (WLAN), or an internet of things (IOT) network.

Various implementations relate generally to mesh networks, and specifically, to enabling multi-link operation (MLO) in a mesh network. In various implementations, a plurality of multi-link devices (MLDs) operating as mesh nodes or peer devices may form a multi-link mesh network by establishing multi-link peering instances with one another as part of a mesh basic service set (MBSS). In some implementations, each peer MLD associated with the mesh network may include a first device associated with a first communication link of the mesh network, and may include one or more second devices associated with one or more respective second communication links of the mesh network. For example, in some instances, the first device of a respective peer MLD may include a first STA and a first AP, and each of the one or more second devices of the respective peer MLD may include a respective second STA and a respective second AP. The first STA of the respective peer MLD may be configured to communicate with one or more previous-hop peer MLDs and one or more next-hop peer MLDs on the first communication link, and the one or more second STAs of the respective peer MLD may be configured to communicate with the one or more previous-hop peer MLDs and the one or more next-hop peer MLDs on the one or more respective second communication links. The first AP of the respective peer MLD may establish a first BSS on the first communication link and communicate with one or more first client devices associated with the first BSS on the first communication link. Each of the one or more second APs of the respective peer MLD may establish a corresponding second BSS on a respective second communication link and communicate with one or more associated second client devices on the respective second communication link.

Aspects of the present disclosure recognize that employing MLDs as nodes in a mesh network may be associated with the exchange of multi-link protocol frames or elements over mesh links established between the MLDs. Although multi-link operation is supported in infrastructure WLANs, as defined in the 802.11be amendments to the Institute of Electrical and Electronic Engineers (IEEE) 802.11 standard, multi-link operation is not currently supported in mesh networks operating according to the 802.11REVme amendments to the IEEE 802.11 standard nor in mesh networks operating according to the Wi-Fi EasyMesh™ Specification published by the Wi-Fi Alliance. Moreover, mesh protocol frames and messages communicated over a mesh network use a different address format than multi-link protocol frames and packets exchanged between MLDs on one or more communication links. For example, while mesh protocol frames and messages use mesh addresses associated with the mesh network, multi-link protocol frames and packets use multi-link addresses that are based on per-link addresses and MLD addresses.

Aspects of the present disclosure recognize that multi-link operation may be enabled in a mesh network by replacing mesh protocol addresses associated with the medium access control (MAC) headers of mesh protocol frames with corresponding multi-link addresses based on per-link receiver and transmitter addresses and MLD source and destination addresses. For example, in some instances, the multi-link protocol addresses may include per-link addresses indicating the per-link receiver and per-link transmitter addresses of a corresponding peering instance, and may include MLD addresses indicating respective MBSS egress and ingress points of the corresponding peering instance. In some aspects, the multi-link protocol addresses also may include MLD addresses indicating source and destination addresses associated with a path established in the mesh network.

In some implementations, peer MLDs operating as nodes in the mesh network may determine, calculate, ascertain or obtain a mapping between mesh protocol addresses and their corresponding multi-link protocol addresses, and may use the mapping to populate the MAC headers of mesh protocol frames with the multi-link protocol addresses. The mesh protocol frames populated with multi-link protocol addresses may include Hybrid Wireless Mesh Protocol (HWMP) Mesh Path Selection frames, Mesh Peering Open frames, Mesh Peering Confirm frames, Mesh Peering Close frames, or Mesh Data frames, among other examples. In some instances, a multi-link context may allow the peer MLDs to discover and associate with one another on all of the communication links of the mesh network based on discovery information, capabilities, or parameters received or otherwise obtained on the first communication link. The multi-link context also may allow the peer MLDs to establish a common security context, common encryption keys, common acknowledgement (BA) sessions, and Traffic Identifier (TID)-to-Link Mappings on all of the communication links of the mesh network based on frame exchanges on the first communication link.

In various implementations, mesh protocol frames communicated on the multi-link peering instances of a mesh network may include a Multi-link element indicating discovery information for each of the communication links associated with the mesh network. The Multi-link element also may indicate one or more MLD capabilities common to the communication links of the mesh network. In some other instances, the mesh protocol frames also may include a Reduced Neighbor Report (RNR) element indicating channel information, operation parameters, and MLD parameters of the one or more second communication links of the mesh network. In some other instances, the mesh protocol frames also may include a TID-to-Link Mapping element indicating, for each of a plurality of TIDs, on which of the multiple communication links that mesh data frames belonging to the respective TID are permitted.

Particular implementations of the subject matter described in this disclosure can be implemented to realize one or more of the following potential advantages. In mapping mesh addresses included in the MAC headers of mesh protocol frames to multi-link protocol addresses indicating at least per-link receiver and transmitter addresses and MLD source and destination addresses, aspects of the present disclosure may allow mesh protocol frames and messages carrying multi-link protocol elements (such as Multi-link elements and TID-to-Link Mapping elements, among other examples) to be propagated across the mesh network by the peer MLDs. In this way, the mesh protocol frames may be used to establish multi-link peering instances between the peer MLDs, and to discover one or more multi-link paths between a source device and a destination device over the multi-link peering instances. The multi-link peering instances and multi-link paths established by the peer MLDs may allow mesh protocol data frames to be propagated across the mesh network on multiple communication links, concurrently, thereby increasing the effective bandwidth of mesh peering instances or mesh links (such as compared to conventional single-link mesh networks). By increasing the effective bandwidth of mesh peering instances or mesh links, implementations of the subject matter disclosed herein may reduce latencies and increase throughput associated with mesh networks.

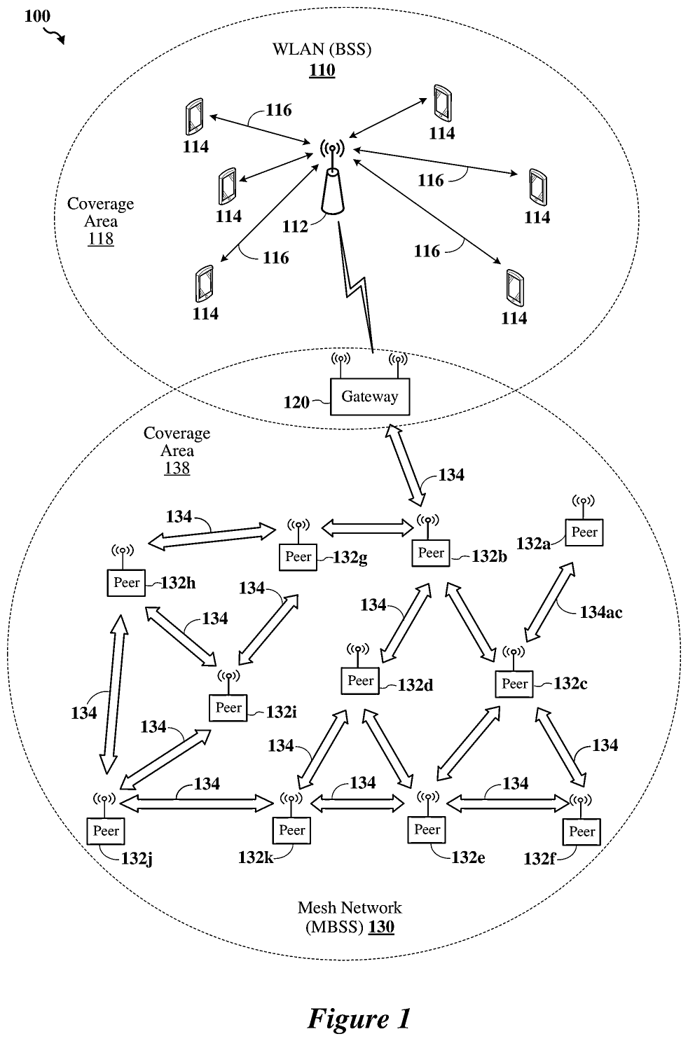

FIG. 1 shows a block diagram of an example wireless communication system 100. According to some aspects, the wireless communication system 100 may include a WLAN 110, a gateway 120, and a mesh network 130. In some implementations, the WLAN 110 can be a network implementing at least one of the IEEE 802.11 family of wireless communications standards (such as that defined by the IEEE 802.11-2016 specification or amendments thereof including, but not limited to, 802.11ah, 802.11ad, 802.11ay, 802.11ax, 802.11az, 802.11ba, and 802.11be). The WLAN 110 may include an access point (AP) 112 and a plurality of wireless stations (STAs) 114. While only one AP 112 is shown in FIG. 1 for simplicity, in other implementations, the WLAN 110 can include multiple APs 112.

Each of the STAs 114 also may be referred to as a mobile station (MS), a mobile device, a mobile handset, a wireless handset, an access terminal (AT), a user equipment (UE), a subscriber station (SS), or a subscriber unit, among other possibilities. The STAs 114 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other possibilities.

A single AP 112 and an associated set of STAs 114 may be referred to as a basic service set (BSS), which is managed by the respective AP 112. FIG. 1 also shows an example coverage area 118 of the AP 112, which may represent a basic service area (BSA) of the WLAN 110. The BSS may be identified to users by a service set identifier (SSID), as well as to other devices by a basic service set identifier (BSSID), which may be a medium access control (MAC) address of the AP 112. The AP 112 periodically broadcasts beacon frames including the BSSID to enable any STAs 114 within wireless range of the AP 112 to associate or re-associate with the AP 112 and establish a respective communication link 116 with the AP 112. In some instances, the beacon frames carry or indicate the operating channel of the communication link used by the AP to advertise discovery information of the AP 112, and may include a timing synchronization function (TSF) for establishing or maintaining timing synchronization with the AP 112. The AP 112 also may provide access to external networks to various STAs 114 in the WLAN 110 a backhaul connection (not shown for simplicity).

To establish a communication link 116 with the AP 112, each of the STAs 114 may be configured to perform passive or active scanning operations on frequency channels in one or more frequency bands (for example, the 2.4 GHz, 5.0 GHz, 6.0 GHz, or 60 GHz frequency bands). To perform passive scanning, a STA 114 listens for beacon frames transmitted by the AP 112 at a periodic time interval referred to as the target beacon transmission time (TBTT) (measured in time units (TUs), where one TU may be equal to 1024 microseconds (μs)). To perform active scanning, a STA 114 generates and sequentially transmits probe requests on each channel to be scanned, and listens for probe responses on the respective channels from the AP 112. Each STA 114 may be configured to identify or select the AP 112 with which to associate based on the scanning information obtained through the passive or active scans, and to perform association and authentication operations to establish the communication link 116 with the AP 112. The AP 112 assigns an association identifier (AID) to each STA 114 at the culmination of the association operations, which the AP 112 uses to track the STAs 114.

As a result of the increasing ubiquity of wireless networks, a STA 114 may have the opportunity to select one of many BSSs within range of the STA 114 or to select among multiple APs 112 that together form an extended service set (ESS) that includes multiple connected BSSs. An extended network station associated with the WLAN 110 may be connected to a wired or wireless distribution system that may allow multiple APs (such as the AP 112) to be connected to one another in such an ESS. As such, a STA 114 can be covered by more than one AP 112, and can associate with different APs 112 at different times for different transmissions. Additionally, after association with the AP 112, a STA 114 also may be configured to periodically scan its surroundings to find a more suitable AP 112 with which to associate. For example, a STA 114 that is moving relative to the STA's associated AP 112 may perform a “roaming” scan to find another AP having more desirable network characteristics such as a greater received signal strength indicator (RSSI) or a reduced traffic load.

In some instances, the STAs 114 may form networks without APs 112 or equipment other than the STAs 114 themselves. One example of such a network is an ad hoc network. Ad hoc networks also may be referred to as mesh networks or peer-to-peer (P2P) networks. As used herein, mesh networks also may include or refer to P2P networks, Personal Area Networks (PANs), and Neighborhood Aware Networks (NANs), among other examples. In some aspects, two of the STAs 114 may communicate with each other via a direct communication link (not shown for simplicity) regardless of whether both STAs 114 are associated with the AP 112. Examples of direct wireless links include Wi-Fi Direct connections, connections established by using a Wi-Fi Tunneled Direct Link Setup (TDLS) link, and other P2P group connections.

The AP 112 and STAs 114 may function and communicate with one another over respective communication links 116 according to the IEEE 802.11 family of standards. These standards define the WLAN radio and baseband protocols for the PHY and medium access control (MAC) layers. The AP 112 and STAs 114 transmit and receive wireless communications to and from one another in the form of physical layer convergence protocol (PLCP) protocol data units (PPDUs). The AP 112 and STAs 114 in the WLAN 110 may transmit PPDUs over an unlicensed spectrum, which may be a portion of spectrum that includes frequency bands traditionally used by Wi-Fi technology, such as the 2.4 GHz frequency band, the 3.6 GHz frequency band, the 5 GHz frequency band, the 60 GHz frequency band, and the 900 MHz frequency band. In some implementations, the AP 112 and STAs 114 described herein may communicate with one another in other frequency bands, such as the 6 GHz frequency band, which may support both licensed and unlicensed communications. The AP 112 and STAs 114 also can be configured to communicate over other frequency bands such as shared licensed frequency bands, where multiple operators may have a license to operate in the same or overlapping frequency band or bands.

Each of the frequency bands may include multiple channels (which may be used as subchannels of a larger bandwidth channel as described herein). For example, PPDUs conforming to the IEEE 802.11n, 802.11ac and 802.11ax standard amendments may be transmitted over the 2.4 GHz and 5 GHz frequency bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels (which may be referred to as subchannels).

Each PPDU is a composite structure that includes a PHY preamble and a payload in the form of a PLCP service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a first portion (or “legacy preamble”) and a second portion (or “non-legacy preamble”). The first portion may be used for packet detection, automatic gain control and channel estimation, among other uses. The first portion also may generally be used to maintain compatibility with legacy devices as well as non-legacy devices. The format of, coding of, and information provided in the second portion of the preamble is based on the particular IEEE 802.11 protocol to be used to transmit the payload.

The gateway 120 is communicatively coupled to the WLAN 110 and the mesh network 130, and may provide an interface through which devices associated with the mesh network 130 can connect to a core network (or some other remote network) via WLAN 110 and the AP 112. Specifically, the gateway 120 can forward frames or packets received from one or more devices associated with the mesh network 130 to the AP 112 for delivery to one or more of the associated STAs 114, or for delivery to other networks (not shown for simplicity) through the AP 112 and various backhaul connections (not shown for simplicity) associated with the AP 112. Similarly, the gateway 120 can forward frames or packets received from the associated STAs 114 or the core network via the AP 112 for delivery to one or more of the devices associated with the mesh network 130. The gateway 120 may include any suitable number of radios and associated transceiver chains that allow the gateway 120 to communicate with the mesh network 130 on multiple communication links, concurrently. In some other implementations, the AP 112 may perform the functions of the gateway 120, which may be omitted.

The mesh network 130 may include a plurality of peer devices 132a-132k configured to operate as mesh devices or “nodes” that can send, receive, broadcast, or forward messages and frames to one another over peering instances 134. As used herein, the term “peer devices 132” may refer to all of the peer devices 132a-132k shown in the example of FIG. 1, and the term “peering instance” may refer to a mesh link or other wireless communication link established between neighbor peer devices 132. In some instances, messages and frames may be broadcasted on a shared wireless medium associated with the mesh network 130, and each peer device 132 that receives a broadcast message or frame may forward the message or frame to one or more neighbor peer devices 132. Each of the one or more neighbor peer devices 132 may forward the message or frame to one or more other neighbor peer devices 132, and so on, until the message or frame reaches its destination. As such, each peer device 132 can be any suitable device capable of sending, receiving, broadcasting, and forwarding messages or frames to other peer devices 132 within radio range of the respective peer device 132. Example peer devices 132 may include, but are not limited to, a mobile station (STA), a laptop, a personal computer (PC), a desktop computer, a personal digital assistant (PDA), a cellular phone, a smart phone, a satellite radio, a global positioning system, a multimedia device, a video device, a digital audio player, a camera, a game console, a tablet, a smart device, a wearable device (such as a smart watch or wireless headphones), a vehicle, an electric meter, a gas pump, a toaster, a thermostat, a hearing aid, a blood glucose on-body unit, an Internet-of-Things (IoT) device, an industrial IoT (IIoT) device, or any other similarly functioning device. In various aspects, the peer devices 132 may be capable of transmitting or receiving messages and frames based on one or more of the Bluetooth Specification, the Bluetooth Low Energy (BLE) Specification, the IEEE 802.11 family of wireless communication standards, or the Wi-Fi Alliance specifications.

In some implementations, the peer devices 132 may operate according to a wireless mesh protocol that allows the peer devices 132 to establish the peering instances 134 between one another using a mesh path selection procedure. Specifically, the peering instances 134 established between a source device and a destination device may form a mesh path on which messages or frames can be propagated from the source device to the destination device by one or more peer devices 132 operating as intermediate nodes of the mesh network 130. In some aspects, the peer devices 132 may discover one another using path discovery messages, and may use discovery and capability information carried in the path discovery messages to determine whether or not neighbor peer devices 132 are suitable candidates with which to establish peering instances 134. For example, in some instances, peer device 132a may broadcast a Path Request (PREQ) message or a Mesh Peering Open frame that includes a request to establish a peering instance 134 with the peer device 132a. The PREQ message or Mesh Peering Open frame also may indicate the capabilities, supported data rates, supported channels, supported operating classes, mesh information, and other parameters associated with the peer device 132a.

Neighboring candidate peer devices 132b and 132c may receive the PREQ message or Mesh Peering Open frame, and may forward the PREQ message or Mesh Peering Open frame to one or more other peer devices 132, and so on, until the PREQ message or Mesh Peering Open frame reaches the destination device. The candidate peer devices 132b and 132c also may send a Path Reply (PREP) message or a Mesh Peering Confirm frame, to the peer device 132a, indicating whether the respective candidate peer device 132b or 132c accepts or rejects the request to establish a peering instance 134 with the peer device 132a. The PREQ message or Mesh Peering Confirm frame also may indicate the capabilities, supported data rates, supported channels, supported operating classes, mesh parameters, and other information pertaining to the respective candidate peer device 132b or 132c. In the example of FIG. 1, a peering instance 134ac is established between the peer device 132a and the candidate peer device 132c after the exchange of corresponding PREQ messages and PREP messages or Mesh Peering Open frames and Mesh Peering Confirm frames. In this way, the wireless mesh protocol may be used to extend the range over which individual peer devices 132 are able to communicate with one another by forming an ad-hoc wireless network having a coverage area 138 that is larger than the radio range of a respective peer device 132.

The frames exchanged during path discovery may carry or indicate one or more link metrics of each peering instance 134 along the discovered path. Each of the peer devices 132 may maintain a forwarding table that stores link metrics associated with one or more “previous hops” and one or more “next hops” traversed by the frames, along with identification information of one or more upstream peer devices 132 associated with the previous hops and one or more downstream peer devices 132 associated with the next hops. For example, when a respective peer device 132 receives a PREQ message from an upstream peer device, the respective peer device 132 may update a corresponding forwarding table with link metrics and identification information carried or indicated by the PREQ message, and may forward the PREQ message to one or more downstream peer devices. Similarly, when the respective peer device 132 receives a PREP message from a downstream peer device, the respective peer device 132 may update the corresponding forwarding table with link metrics and identification information carried or indicated by the PREP message, and may forward the PREP message to one or more upstream peer devices. The link metrics obtained during path discovery may be used to select the most suitable path from a source device to a destination device over the peering instances 134. In various aspects, the most suitable path may refer to one or more of the shortest path, the lowest cost path, or the path associated with the highest link quality.

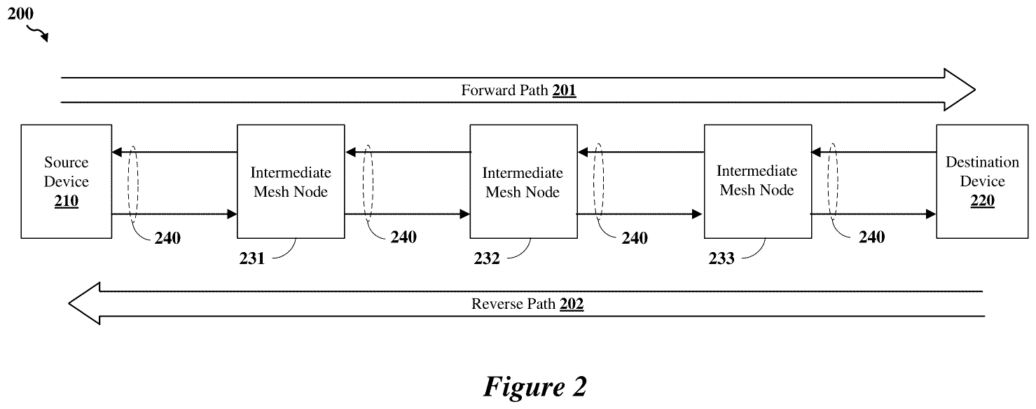

FIG. 2 shows a block diagram of an example path 200 that may be established in a mesh network. The path 200 extends between a source device 210 and a destination device 220 through one or more intermediate mesh nodes 231-233 associated with the mesh network. The path 200 may be associated with a forward path 201 along which messages and frames can be sent from upstream peer devices to downstream peer devices over peering instances 240 towards the destination device 220. The path 200 also may be associated with a reverse path 202 along which messages and frames can be sent from downstream peer devices to upstream peer devices over peering instances 240 towards the source device 210. Although the example of FIG. 2 shows three intermediate mesh nodes 231-233 and four peering instances 240, in some other implementations, the path 200 may include other numbers of intermediate mesh nodes and peering instances. In some instances, the path 200 may be established in the mesh network 130 of FIG. 1 using the HWMP path selection protocol according to the 802.11REVme amendments to the IEEE 802.11 wireless standard.

The source device 210 may be any suitable device that can initiate path discovery in the mesh network, and the destination device 220 may be any suitable device that can receive messages or frames from the source device 210. In some instances, the source device 210 may be a mesh device associated with the mesh network. In some other instances, the source device 210 may be a mesh device located outside of the mesh network or not associated with the mesh network. In some other instances, the source device 210 may be a device associated with another network (such as one of the STAs 114 associated with the WLAN 110 of FIG. 1). Similarly, the destination device 220 may be a mesh device associated with the mesh network, may be a mesh device located outside of the mesh network or not associated with the mesh network, or may be a device associated with another network (such as one of the STAs 114 associated with the WLAN 110 of FIG. 1).

The intermediate mesh nodes 231-233 may be any suitable device that can propagate messages or frames received from a first mesh node to one or more second mesh nodes over the peering instances 240. For example, in some instances, each of the intermediate mesh nodes 231-233 may receive discovery messages or frames from one or more previous-hop mesh nodes, update a corresponding forwarding table with discovery information, capability information, and node identification information obtained from the received discovery messages or frames, and forward the discovery messages or frames to one or more next-hop mesh nodes along the forward path 201 towards the destination device 220. Similarly, each of the intermediate mesh nodes 231-233 may receive discovery messages or frames from one or more next-hop mesh nodes, update the corresponding forwarding table with discovery information, capability information, and node identification information obtained from the received discovery messages or frames, and forward the discovery messages or frames to the one or more previous-hop mesh nodes along the reverse path 202 towards the source device 210.

For example, during path discovery, the source device 210 may broadcast PREQ messages over a shared wireless medium associated with the mesh network. Each of intermediate mesh nodes 231-233 that receives a PREQ message updates the corresponding forwarding table, and forwards the PREQ message to one or more next-hop mesh nodes, which in turn forward the PREQ message to one or more other next-hop mesh nodes closer to the destination device 220, and so on, until one or more PREQ messages reach the destination device 220. The intermediate mesh nodes 231-233 also may update the link metrics carried in PREQ messages received from previous-hop mesh nodes to include the link metrics of respective peering instances 240.

The destination device 220 may respond to receiving a PREQ message by broadcasting PREP messages over the shared wireless medium associated with the mesh network. The intermediate mesh nodes 231-233 receive the PREP messages, update their corresponding forwarding tables, and forward the PREP messages to the one or more previous-hop mesh nodes, which in turn forward the PREP messages to one or more other previous-hop mesh nodes closer to the source device 210, and so on, until one or more PREP messages reach the source device 210. When the source device 210 receives a PREP message, the path 200 may be established between the source device 210 and the destination device 220 along the peering instances 240 traversed by the PREP message and a corresponding PREQ message. In some instances, the destination device 220 may subsequently receive additional PREQ messages indicating better link metrics than the established path 200, and may send updated path information to the source device 210. In some aspects, the source device 210 may establish a new path to the destination device 220 based on the updated path information, for example, to achieve one or more of lower latencies, higher throughput, or lower cost.

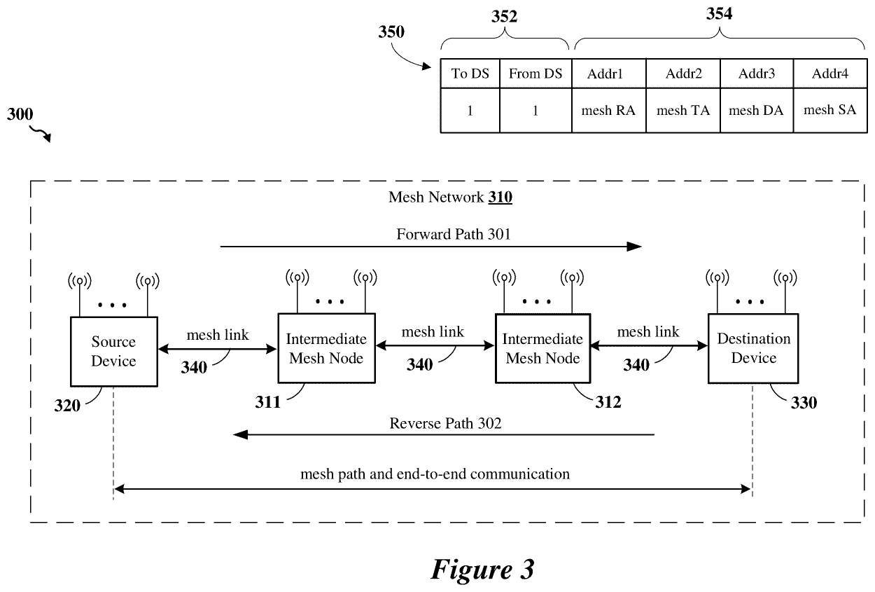

FIG. 3 shows a block diagram of an example path 300 that may be established in a mesh network 310. In some instances, the mesh network 310 may be an example of the mesh network 130 of FIG. 1. The path 300 extends from a source device 320 to a destination device 330 along mesh links 340 and intermediate mesh nodes 311 and 312. In some instances, the mesh links 340 may be examples of the peering instances 240 described with reference to FIG. 2. The path 300 may be associated with a forward path 301 on which messages and frames can be propagated from the source device 320 to the destination device 330 on mesh links 340 by the intermediate mesh nodes 311-312. The path 300 also may be associated with a reverse path 302 on which messages and frames can be propagated from the destination device 330 to the source device 320 on mesh links 340 by the intermediate mesh nodes 311-312. In some instances, the intermediate mesh nodes 311-312 may be mesh devices or peer devices as described with reference to FIG. 1. Although the example of FIG. 3 shows two intermediate mesh nodes 311-312 and three mesh links 340, in some other implementations, the path 300 may include other numbers of intermediate mesh nodes or mesh links.

In the example of FIG. 3, the source device 320 and the destination device 330 are both mesh devices associated with the mesh network 310. As such, the path 300 may be a mesh path corresponding to the end-to-end communication between the source device 320 and the destination device 330, and therefore frames and messages can be exchanged between the source device 320 and the destination device 330 via mesh links 340 without the presence or assistance of other wireless networks. Frames and messages that can be exchanged between source and destination devices on mesh links 340 without the assistance of other wireless networks may use the four-address MAC header specified in the 802.11REVme amendments to the IEEE 802.11 standard.

For example, in some instances, frames or messages exchanged between the source device 320 and the destination device 330 of FIG. 3 may include a MAC header 350 including a distribution system (DS) address field 352 and the four-address field 354 specified in the 802.11REVme amendments to the IEEE 802.11 standard. The DS address field 352 includes a TO DS address carrying a value of 1, and includes a FROM DS address carrying a value of 1. The four-address field 354 includes an Addr1 field carrying the mesh Receiver Address (RA), an Addr2 field carrying the mesh Transmitter Address (TA), an Addr3 field carrying the mesh Destination Address (DA), and an Addr4 field carrying the mesh Source Address (SA). In the example of FIG. 3, the Addr1 field may indicate the MAC address of intermediate mesh node 311, the Addr2 field may indicate the MAC address of intermediate mesh node 312, the Addr3 field may indicate the MAC address of the destination device 330, and the Addr4 field may indicate the MAC address of the source device 320.

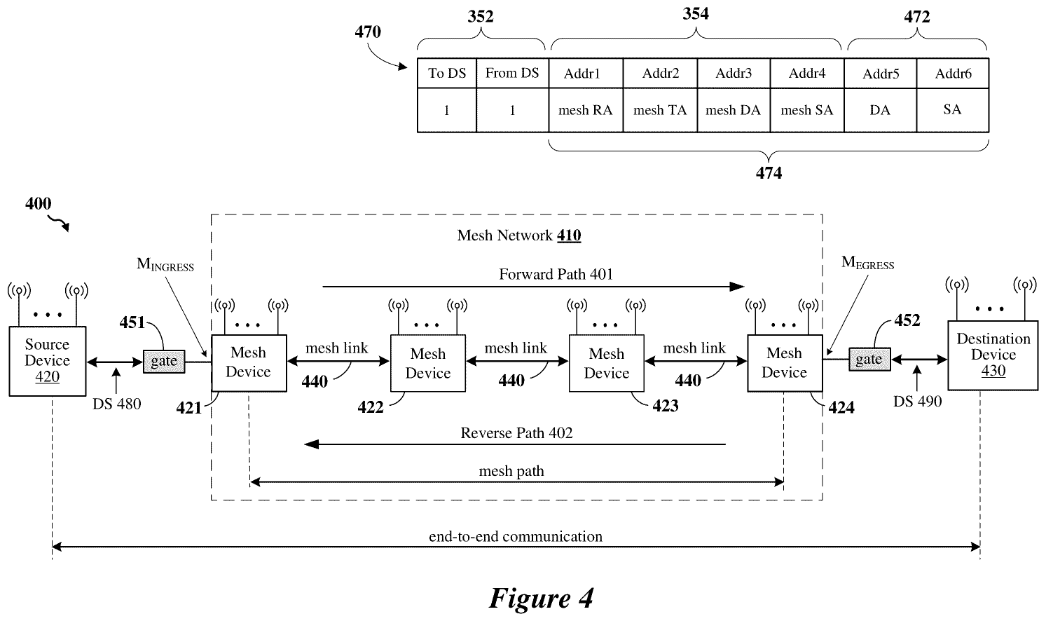

FIG. 4 shows a block diagram of another example path 400 that may be established in a mesh network 410. In some instances, the mesh network 410 may be an example of the mesh network 130 of FIG. 1. The path 400 extends from a source device 420 to a destination device 430 along mesh links 440 and intermediate mesh nodes 421-424. In some instances, the mesh links 440 may be examples of the peering instances 240 described with reference to FIG. 2. The path 400 may be associated with a forward path 401 on which messages and frames can be propagated from the source device 420 to the destination device 430 on mesh links 440, and may be associated with a reverse path 402 on which messages and frames can be propagated from the destination device 430 to the source device 420 over the mesh links 440. Although the example of FIG. 4 shows four intermediate mesh nodes 421-424 and three mesh links 440, in some other implementations, the path 400 may include other numbers of intermediate mesh nodes or mesh links.

In the example of FIG. 4, the source device 420 and the destination device 430 are not a part of (nor associated with) the mesh network 410. That is, while the end-to-end communication in the example of FIG. 4 extends between the source device 420 and the destination device 430, mesh paths established on mesh links 440 extend between a mesh ingress point (M_{INGRESS}) associated with a first intermediate mesh node 421 and a mesh egress point (M_{EGRESS}) associated with a last intermediate mesh node 424. As such, frames and messages cannot be exchanged between the source device 420 and the destination device 430 via mesh links 440 without the assistance of other nearby wireless networks or distribution systems that can provide interfaces between the mesh network 410 and each of the source and destination devices 420 and 430.

In the example of FIG. 4, a first gateway device 451 is coupled to the mesh network 410 and configured to use a first Distribution System (DS) 480 as an interface between the source device 420 and the mesh ingress point (M_{INGRESS}), and a second gateway device 452 is coupled to the mesh network 410 and configured to use a second DS 490 as an interface between the destination device 430 and the mesh egress point (M_{EGRESS}). Frames and messages exchanged between the source and destination devices 420 and 430 on mesh links 440 and other wireless networks or distribution systems may use the six-address MAC header specified in the 802.11REVme amendments to the IEEE 802.11 standard.

For example, in some instances, frames or messages exchanged between the source and destination devices 420 and 430 of FIG. 4 may include a MAC header 470 that includes the DS address field 352 described with reference to FIG. 3, the four-address field 354 described with reference to FIG. 3, and an extension field 472 that includes an Addr5 field and an Addr6 field. Together, the four-address field 354 and the two-address extension field 472 form a six-address field 474 specified by the 802.11REVme amendments to the IEEE 802.11 standard. The Addr5 field may carry or indicate the destination address (DA) associated with destination device 430, and the Addr6 field may carry or indicate the source address (SA) associated with the source device 420. In the example of FIG. 4, the Addr1 field may indicate the MAC address of intermediate mesh node 423 (as the receiving mesh node on the mesh link), the Addr2 field may indicate the MAC address of intermediate mesh node 422 (as the transmitting mesh node on the mesh link), the Addr3 field may indicate the MAC address of mesh node 424 (as the destination mesh node), the Addr4 field may indicate the MAC address of mesh node 421 (as the source mesh node), the Addr5 field may indicate the MAC address of the destination device 430 (as the destination), and the Addr6 field may indicate the MAC address of the source device 420 (as the source). In some other instances, the Addr3 field may indicate the MAC address of the mesh egress point M_{EGRESS}, and the Addr4 field may indicate the MAC address of the mesh ingress point M_{INGRESS}.

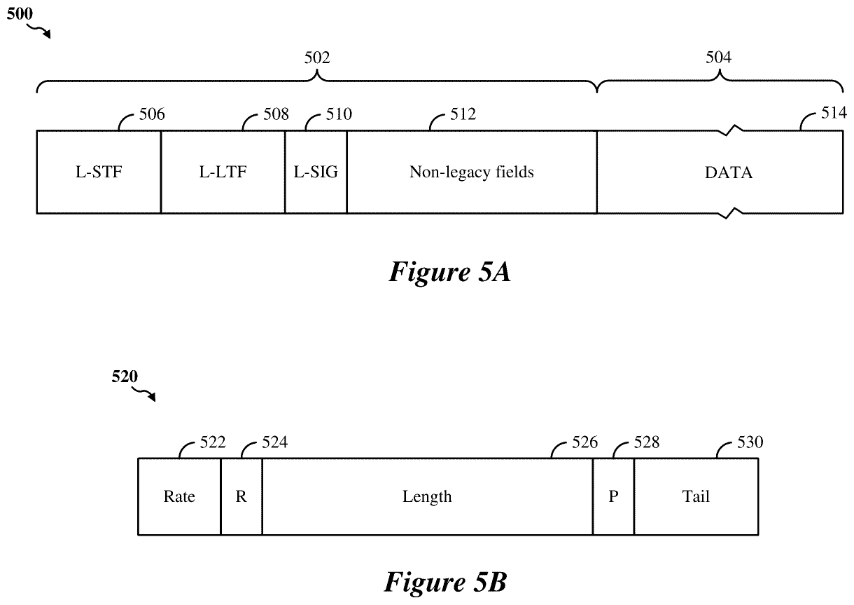

FIG. 5A shows an example protocol data unit (PDU) 500 usable for wireless communication between an AP 112 and one or more STAs 114. For example, the PDU 500 can be configured as a PPDU. As shown, the PDU 500 includes a PHY preamble 502 and a payload 504. For example, the preamble 502 may include a legacy portion that itself includes a legacy short training field (L-STF) 506, which may consist of two BPSK symbols, a legacy long training field (L-LTF) 508, which may consist of two BPSK symbols, and a legacy signal field (L-SIG) 510, which may consist of two BPSK symbols. The legacy portion of the preamble 502 may be configured according to the IEEE 802.11a wireless communication protocol standard. The preamble 502 also may include a non-legacy portion including one or more non-legacy fields 512, for example, conforming to an IEEE wireless communication protocol such as the IEEE 802.11ac, 802.11ax, 802.11be or later wireless communication protocol protocols.

The L-STF 506 generally enables a receiving device to perform automatic gain control (AGC) and coarse timing and frequency estimation. The L-LTF 508 generally enables a receiving device to perform fine timing and frequency estimation and also to perform an initial estimate of the wireless channel. The L-SIG 510 generally enables a receiving device to determine a duration of the PDU and to use the determined duration to avoid transmitting on top of the PDU. For example, the L-STF 506, the L-LTF 508 and the L-SIG 510 may be modulated according to a binary phase shift keying (BPSK) modulation scheme. The payload 504 may be modulated according to a BPSK modulation scheme, a quadrature BPSK (Q-BPSK) modulation scheme, a quadrature amplitude modulation (QAM) modulation scheme, or another appropriate modulation scheme. The payload 504 may include a PSDU including a data field (DATA) 514 that, in turn, may carry higher layer data, for example, in the form of medium access control (MAC) protocol data units (MPDUs) or an aggregated MPDU (A-MPDU).

FIG. 5B shows an example L-SIG 510 in the PDU 500 of FIG. 5A. The L-SIG 510 includes a data rate field 522, a reserved bit 524, a length field 526, a parity bit 528, and a tail field 530. The data rate field 522 indicates a data rate (note that the data rate indicated in the data rate field 522 may not be the actual data rate of the data carried in the payload 504). The length field 526 indicates a length of the packet in units of, for example, symbols or bytes. The parity bit 528 may be used to detect bit errors. The tail field 530 includes tail bits that may be used by the receiving device to terminate operation of a decoder (for example, a Viterbi decoder). The receiving device may utilize the data rate and the length indicated in the data rate field 522 and the length field 526 to determine a duration of the packet in units of, for example, microseconds (μs) or other time units.

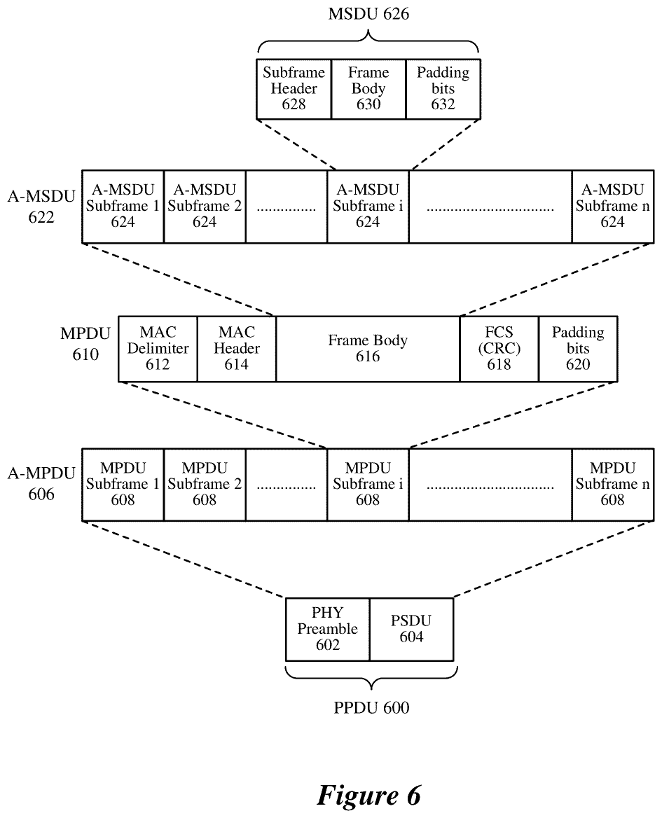

FIG. 6 shows an example PPDU 600 usable for communications between an AP 112 and a number of STAs 114. As described, each PPDU 600 includes a PHY preamble 602 and a PSDU 604. Each PSDU 604 may carry one or more MAC protocol data units (MPDUs), for example, such as an aggregated MPDU (A-MPDU) 606 that includes multiple MPDU subframes 608. Each MPDU subframe 608 may include a MAC delimiter 612 and a MAC header 614 prior to the accompanying frame body 616, which includes the data portion or “payload” of the MPDU subframe 608. The frame body 616 may carry one or more MAC service data units (MSDUs), for example, such as an aggregated MSDU (A-MSDU) 622 that includes multiple MSDU subframes 624. Each MSDU subframe 624 contains a corresponding MSDU 626 including a subframe header 628, a frame body 630, and one or more padding bits 632.

With reference to the A-MPDU 606, the MAC header 614 may include a number of fields containing information that defines or indicates characteristics or attributes of data encapsulated within the frame body 616. The MAC header 614 also includes a number of fields indicating addresses for the data encapsulated within the frame body 616. For example, the MAC header 614 may include a combination of a source address, a transmitter address, a receiver address, or a destination address. The MAC header 614 may include a frame control field containing control information. The frame control field specifies the frame type, for example, a data frame, a control frame, or a management frame. The MAC header 614 also may include a duration field indicating a duration extending from the end of the PPDU until the end of an acknowledgment (ACK) of the last PPDU to be transmitted by the wireless communication device (for example, a block ACK (BA) in the case of an A-MPDU). The use of the duration field serves to reserve the wireless medium for the indicated duration, thus establishing the NAV. Each A-MPDU subframe 608 also may include a frame check sequence (FCS) field 618 for error detection. For example, the FCS field 618 may include a cyclic redundancy check (CRC), and may be followed by one or more padding bits 620.

As described, APs 112 and STAs 114 can support multi-user (MU) communications. That is, concurrent transmissions from one device to each of multiple devices (for example, multiple simultaneous downlink (DL) communications from an AP 112 to corresponding STAs 114), or concurrent transmissions from multiple devices to a single device (for example, multiple simultaneous uplink (UL) transmissions from corresponding STAs 114 to an AP 112). To support the MU transmissions, the APs 112 and STAs 114 may utilize multi-user multiple-input, multiple-output (MU-MIMO) and partial bandwidth (BW) MU-MIMO techniques.

In partial BW MU-MIMO schemes, the available frequency spectrum of the wireless channel may be divided into multiple resource units (RUs) each including a number of different frequency subcarriers (“tones”). Different RUs may be allocated or assigned by an AP 112 to different STAs 114 at particular times. The sizes and distributions of the RUs may be referred to as an RU allocation. In some implementations, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Larger 52 tone, 106 tone, 242 tone, 484 tone and 996 tone RUs also may be allocated. Adjacent RUs may be separated by a null subcarrier (such as a DC subcarrier), for example, to reduce interference between adjacent RUs, to reduce receiver DC offset, and to avoid transmit center frequency leakage.

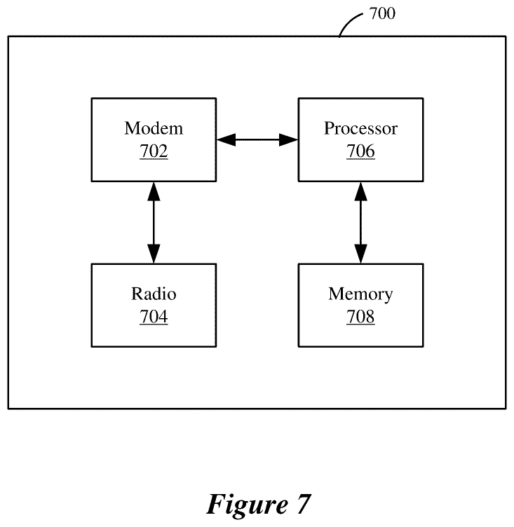

FIG. 7 shows a block diagram of an example wireless communication device 700. In some implementations, the wireless communication device 700 can be an example of a device for use in a STA such as one of the STAs 114 described with reference to FIG. 1. In some implementations, the wireless communication device 700 can be an example of a device for use in an AP such as the AP 112 described with reference to FIG. 1. The wireless communication device 700 is capable of transmitting (or outputting for transmission) and receiving wireless communications (for example, in the form of wireless packets). For example, the wireless communication device 700 can be configured to transmit and receive packets in the form of physical layer convergence protocol (PLCP) protocol data units (PPDUs) and medium access control (MAC) protocol data units (MPDUs) conforming to an IEEE 802.11 standard, such as that defined by the IEEE 802.11-2016 specification or amendments thereof including, but not limited to, 802.11ah, 802.11ad, 802.11ay, 802.11ax, 802.11az, 802.11ba, and 802.11be.

The wireless communication device 700 can be, or can include, a chip, system on chip (SoC), chipset, package, or device that includes one or more modems 702, for example, a Wi-Fi (IEEE 802.11 compliant) modem. In some implementations, the one or more modems 702 (collectively “the modem 702”) additionally include a WWAN modem (for example, a 3GPP 4G LTE or 5G compliant modem). In some implementations, the wireless communication device 700 also includes one or more radios 704 (collectively “the radio 704”). In some implementations, the wireless communication device 700 further includes one or more processors, processing blocks or processing elements (collectively “the processor 706”), and one or more memory blocks or elements (collectively “the memory 708”).

The modem 702 can include an intelligent hardware block or device such as, for example, an application-specific integrated circuit (ASIC) among other possibilities. The modem 702 is configured to implement a PHY layer. For example, the modem 702 is configured to modulate packets and to output the modulated packets to the radio 704 for transmission over the wireless medium. The modem 702 is similarly configured to obtain modulated packets received by the radio 704 and to demodulate the packets to provide demodulated packets. In addition to a modulator and a demodulator, the modem 702 also may include digital signal processing (DSP) circuitry, automatic gain control (AGC), a coder, a decoder, a multiplexer, and a demultiplexer. For example, while in a transmission mode, data obtained from the processor 706 is provided to a coder, which encodes the data to provide encoded bits. The encoded bits are mapped to points in a modulation constellation (using a selected MCS) to provide modulated symbols. The modulated symbols may be mapped to a number N_{SS} of spatial streams or a number N_{STS} of space-time streams. The modulated symbols in the respective spatial or space-time streams may be multiplexed, transformed via an inverse fast Fourier transform (IFFT) block, and provided to the DSP circuitry for Tx windowing and filtering. The digital signals may be provided to a digital-to-analog converter (DAC). The resultant analog signals may be provided to a frequency upconverter, and the radio 704. In implementations involving beamforming, the modulated symbols in the respective spatial streams are precoded via a steering matrix prior to their provision to the IFFT block.

While in a reception mode, digital signals received from the radio 704 are provided to the DSP circuitry, which is configured to acquire a received signal, for example, by detecting the presence of the signal and estimating the initial timing and frequency offsets. The DSP circuitry is further configured to digitally condition the digital signals, for example, using channel (narrowband) filtering, analog impairment conditioning (such as correcting for I/Q imbalance), and applying digital gain to obtain a narrowband signal. The output of the DSP circuitry may be fed to the AGC, which is configured to use information extracted from the digital signals, for example, in one or more received training fields, to determine an appropriate gain. The output of the DSP circuitry also is coupled with the demodulator, which is configured to extract modulated symbols from the signal and, for example, compute the logarithm likelihood ratios (LLRs) for each bit position of each subcarrier in each spatial stream. The demodulator is coupled with the decoder, which may be configured to process the LLRs to provide decoded bits. The decoded bits from all of the spatial streams are fed to the demultiplexer for demultiplexing. The demultiplexed bits may be descrambled and provided to the MAC layer (the processor 706) for processing, evaluation, or interpretation.

The radio 704 includes at least one radio frequency (RF) transmitter (or “transmitter chain”) and at least one RF receiver (or “receiver chain”), which may be combined into one or more transceivers. For example, the RF transmitters and receivers may include various DSP circuitry including at least one power amplifier (PA) and at least one low-noise amplifier (LNA), respectively. The RF transmitters and receivers may in turn be coupled to one or more antennas. For example, in some implementations, the wireless communication device 700 can include, or be coupled with, multiple transmit antennas (each with a corresponding transmit chain) and multiple receive antennas (each with a corresponding receive chain). The symbols output from the modem 702 are provided to the radio 704, which transmits the symbols via the coupled antennas. Similarly, symbols received via the antennas are obtained by the radio 704, which provides the symbols to the modem 702.

The processor 706 can include an intelligent hardware block or device such as, for example, a processing core, a processing block, a central processing unit (CPU), a microprocessor, a microcontroller, a digital signal processor (DSP), an application-specific integrated circuit (ASIC), a programmable logic device (PLD) such as a field programmable gate array (FPGA), discrete gate or transistor logic, discrete hardware components, or any combination thereof designed to perform the functions described herein. The processor 706 processes information received through the radio 704 and the modem 702, and processes information to be output through the modem 702 and the radio 704 for transmission through the wireless medium. For example, the processor 706 may implement a control plane and MAC layer configured to perform various operations related to the generation and transmission of MPDUs, frames, or packets. The MAC layer is configured to perform or facilitate the coding and decoding of frames, spatial multiplexing, space-time block coding (STBC), beamforming, and OFDMA resource allocation, among other operations or techniques. In some implementations, the processor 706 may control the modem 702 to cause the modem to perform various operations described herein.

The memory 708 can include tangible storage media such as random-access memory (RAM) or read-only memory (ROM), or combinations thereof. The memory 708 also can store non-transitory processor- or computer-executable software (SW) code containing instructions that, when executed by the processor 706, cause the processor to perform various operations described herein for wireless communication, including the generation, transmission, reception, and interpretation of MPDUs, frames or packets. For example, various functions of components disclosed herein, or various blocks or steps of a method, operation, process, or algorithm disclosed herein, can be implemented as one or more modules of one or more computer programs.

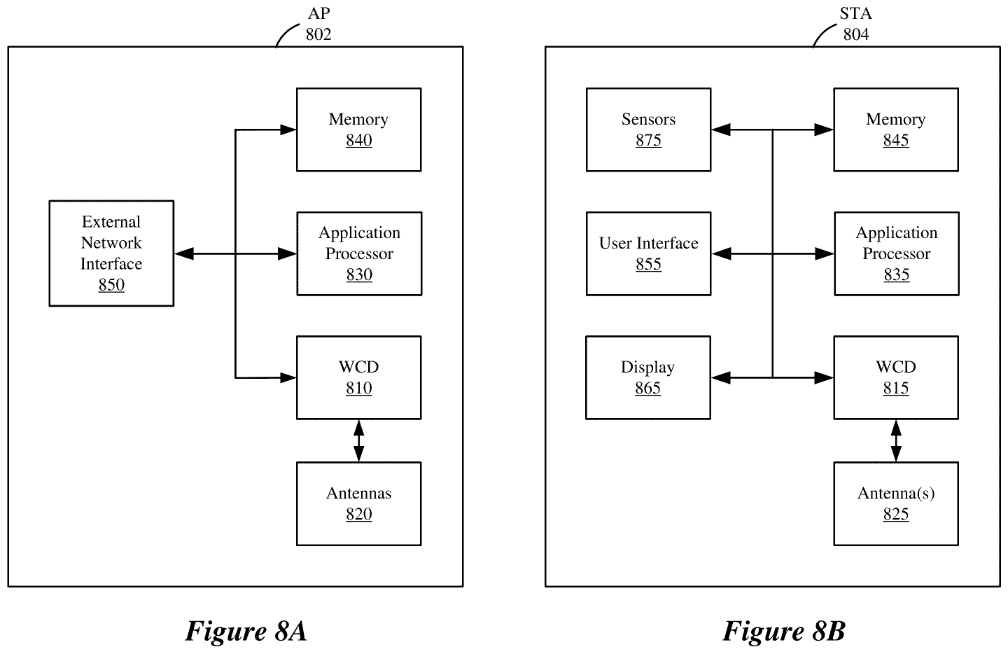

FIG. 8A shows a block diagram of an example AP 802. For example, the AP 802 can be an example implementation of the AP 112 described with reference to FIG. 1. The AP 802 includes a wireless communication device (WCD) 810. For example, the wireless communication device 810 may be an example implementation of the wireless communication device 700 described with reference to FIG. 7. The AP 802 also includes multiple antennas 820 coupled with the wireless communication device 810 to transmit and receive wireless communications. In some implementations, the AP 802 additionally includes an application processor 830 coupled with the wireless communication device 810, and a memory 840 coupled with the application processor 830. The AP 802 further includes at least one external network interface 850 that enables the AP 802 to communicate with a core network or backhaul network to gain access to external networks including the Internet. For example, the external network interface 850 may include one or both of a wired (for example, Ethernet) network interface and a wireless network interface (such as a WWAN interface). Ones of the aforementioned components can communicate with other ones of the components directly or indirectly, over at least one bus. The AP 802 further includes a housing that encompasses the wireless communication device 810, the application processor 830, the memory 840, and at least portions of the antennas 820 and external network interface 850. In some implementations, the application processor 830 and the memory 840 may be components of a processing system. A processing system may generally refer to a system or series of machines or components that receives inputs and processes the inputs to produce a set of outputs (which may be passed to other systems or components of the AP 802). For example, a processing system of the AP 802 may refer to a system including the various other components or subcomponents of the AP 802.

The processing system of the AP 802 may interface with other components of the AP 802, and may process information received from other components (such as inputs or signals), output information to other components, and the like. For example, a chip or modem of the AP 802 may include a processing system, a first interface to receive or obtain information, and a second interface to output or transmit information. In some instances, the first interface may refer to an interface between the processing system of the chip or modem and a receiver, such that the AP 802 may receive information or signal inputs, and the information may be passed to the processing system. In some instances, the second interface may refer to an interface between the processing system of the chip or modem and a transmitter, such that the AP 802 may transmit information output from the chip or modem. A person having ordinary skill in the art will readily recognize that the second interface also may obtain or receive information or signal inputs, and the first interface also may output, transmit or provide information.

FIG. 8B shows a block diagram of an example STA 804. For example, the STA 804 can be an example implementation of the STA 114 described with reference to FIG. 1. The STA 804 includes a wireless communication device 815. For example, the wireless communication device 815 may be an example implementation of the wireless communication device 700 described with reference to FIG. 7. The STA 804 also includes one or more antennas 825 coupled with the wireless communication device 815 to transmit and receive wireless communications. The STA 804 additionally includes an application processor 835 coupled with the wireless communication device 815, and a memory 845 coupled with the application processor 835. In some implementations, the STA 804 further includes a user interface (UI) 855 (such as a touchscreen or keypad) and a display 865, which may be integrated with the UI 855 to form a touchscreen display. In some implementations, the STA 804 also may include one or more sensors 875 such as, for example, one or more inertial sensors, accelerometers, temperature sensors, pressure sensors, or altitude sensors. Ones of the aforementioned components can communicate with other ones of the components directly or indirectly, over at least one bus. The STA 804 further includes a housing that encompasses the wireless communication device 815, the application processor 835, the memory 845, and at least portions of the antennas 825, UI 855, and display 865. In some implementations, the application processor 835 and the memory 845 may be components of a processing system. A processing system may generally refer to a system or series of machines or components that receives inputs and processes the inputs to produce a set of outputs (which may be passed to other systems or components of the STA 804). For example, a processing system of the STA 804 may refer to a system including the various other components or subcomponents of the STA 804.

The processing system of the STA 804 may interface with other components of the STA 804, and may process information received from other components (such as inputs or signals), output information to other components, and the like. For example, a chip or modem of the STA 804 may include a processing system, a first interface to receive or obtain information, and a second interface to output or transmit information. In some instances, the first interface may refer to an interface between the processing system of the chip or modem and a receiver, such that the STA 804 may receive information or signal inputs, and the information may be passed to the processing system. In some instances, the second interface may refer to an interface between the processing system of the chip or modem and a transmitter, such that the STA 804 may transmit information output from the chip or modem. A person having ordinary skill in the art will readily recognize that the second interface also may obtain or receive information or signal inputs, and the first interface also may output, transmit or provide information.

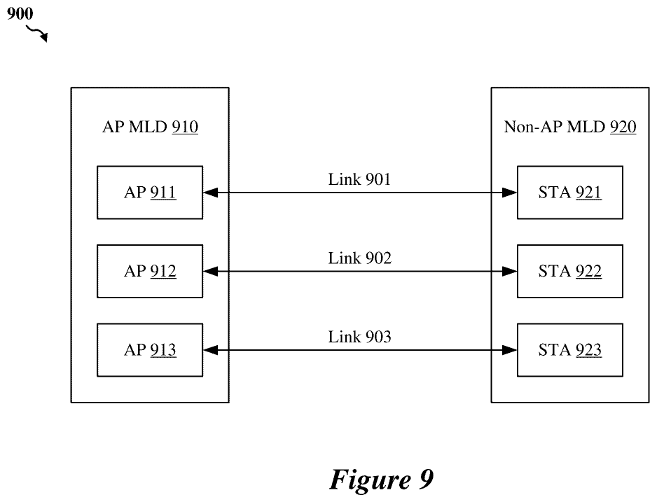

FIG. 9 shows an example communication system 900 that includes an AP MLD 910 and a non-AP MLD 920. In some aspects, the AP MLD 910 may be one example of the AP 112 of FIG. 1, the wireless communication device 700 of FIG. 7, or the AP 802 of FIG. 8A. The non-AP MLD 920 may be one example of the STAs 114 FIG. 1, the wireless communication device 700 of FIG. 7, or the STA 804 of FIG. 8B. In various implementations, one or both of the AP MLD 910 and the STA MLD 920 may be used as peer devices in an ad hoc wireless network such as a mesh network. Specifically, a plurality of AP MLDs 910, STA MLDs 920, or other MLDs may be configured to establish multi-link peering instances between one another, and to discover the best-suited path from a source device to a destination device using the multi-link peering instances. In this way, the MLDs may, at least in some aspects, operate as mesh nodes that can receive mesh protocol discovery messages and frames from one or more previous-hop mesh devices, update their respective forwarding tables with discovery information and link metrics obtained from the mesh protocol discovery messages or frames, and forward the mesh protocol discovery messages or frames to one or more next-hop mesh devices.

The AP MLD 910 includes multiple APs 911-913 associated with (or operating on) respective communication links 901-903. In the example of FIG. 9, the AP MLD 910 is shown to include 3 APs 911-913. In other implementations, the AP MLD 910 may include fewer or more APs than those depicted in FIG. 9. Although the APs 911-913 may share a common association context (through the AP MLD 910), each of the APs 911-913 may establish a respective BSS on the AP's associated communication link. The APs 911-913 also may establish their respective communication links 901-903 on different frequency bands. For example, the AP 911 may operate on the 2.4 GHz frequency band, the AP 912 may operate on the 5 GHz frequency band, and the AP 913 may operate on the 6 GHz frequency band.

The non-AP MLD 920 includes multiple STAs 921-923 that may be configured to communicate on the communication links 901-903, respectively. Thus, the STA 921 may operate on the 2.4 GHz frequency band, the STA 922 may operate on the 5 GHz frequency band, and the STA 923 may operate on the 6 GHz frequency band. In the example of FIG. 9, the non-AP MLD 920 is shown to include only 3 STAs. However, in some implementations, the non-AP MLD 920 may include fewer or more STAs than those depicted in FIG. 9. The IEEE 802.11be amendment of the IEEE 802.11 standard defines several modes in which a non-AP MLD may operate. The various operating modes depend on the number of wireless radios associated with the non-AP MLD and the non-AP MLD's ability to communicate (such as by transmitting or receiving) concurrently on multiple communication links.

In some implementations, the non-AP MLD 920 may include a single radio or may otherwise be capable of communicating on only one link at a time. In such implementations, the non-AP MLD 920 may operate in a multi-link single-radio (MLSR) mode or an enhanced MLSR (EMLSR) mode. A non-AP MLD operating in the EMLSR mode can listen for specific types of communications (such as buffer status report poll (BSRP) frames or multi-user request-to-send (MU-RTS) frames) on multiple communication links, concurrently, but can only transmit or receive on one communication link at any given time. For example, the STAs 921 and 922 may concurrently listen on their respective links 901 and 902 during a listen interval. However, if the STA 921 detects a BSRP frame on link 901, the non-AP MLD 920 subsequently tunes each of the non-AP MLD's antennas (including the antenna used by the STA 922 during the listen interval) to operate on link 901. By contrast, a non-AP MLD operating in the MLSR mode can only listen to, and transmit or receive on, one communication link at any given time. For example, the STA 921 must be in a power save mode at times during which the STA 922 is active.

In some other implementations, the non-AP MLD 920 may include multiple radios and may be capable of concurrent communications on each of the links 901-903. In such implementations, the non-AP MLD 920 may operate in a multi-link multi-radio (MLMR) simultaneous transmit and receive (STR) mode or a multi-link multi-radio non-STR (NSTR) mode. A non-AP MLD operating in the MLMR STR mode can simultaneously (or concurrently) transmit and receive on multiple communication links. For example, the STA 921 may transmit or receive on link 901 while the STA 922 concurrently transmits or receives on link 902, asynchronously. By contrast, a non-AP MLD operating in the MLMR NSTR mode can simultaneously transmit and receive on multiple communication links only if such communications are synchronous. For example, the STAs 922 and 923 may concurrently transmit on links 902 and 903 and may concurrently receive on links 902 and 903. However, the STA 922 cannot be transmitting on link 902 while the STA 923 is receiving on link 903.

Still further, a non-AP MLD may include multiple radios but may be capable of concurrent communications on only a subset of the links. In such implementations, the non-AP MLD 920 may operate in an enhanced MLMR (EMLMR) mode or a hybrid EMLSR mode. A non-AP MLD operating in the EMLMR mode supports MLMR STR operation between certain pairs of communication links. For example, the STAs 921 and 922 may concurrently communicate on their respective links 901 and 902 in accordance with the MLMR STR mode of operation.

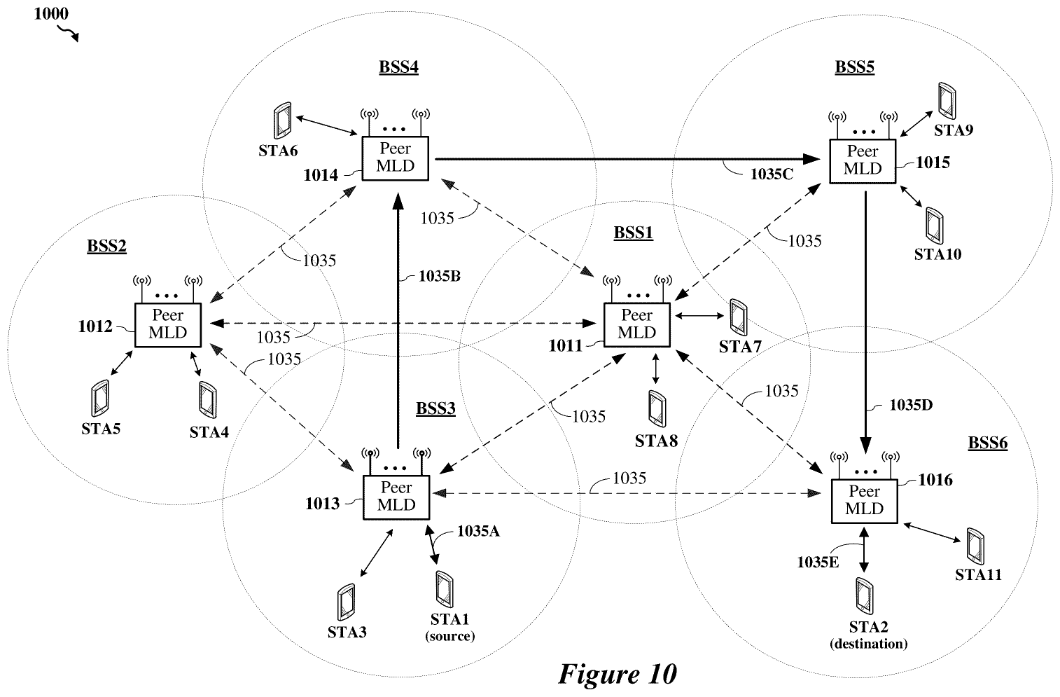

FIG. 10 shows a block diagram of a wireless mesh network 1000 that supports multi-link operation. The mesh network 1000 may include a plurality of peer multi-link devices (MLDs) 1011-1016 operating as mesh nodes that can send, receive, forward, and broadcast mesh protocol messages and frames to one another over multi-link peering instances 1035. As used herein, the terms “peering instance” and “mesh link” refer to communication links established between mesh nodes or devices associated with the mesh network during path discovery operations. As such, the terms “peering instance” and “mesh link” are interchangeable with each other throughout the present disclosure. Although the example of FIG. 10 shows six peer MLDs 1011-1016, in some other implementations, the mesh network 1000 can include other numbers of peer MLDs.

The peer MLDs 1011-1016 may be any suitable wireless communication device capable of establishing multi-link peering instances 1035 between one another to form an ad hoc network that operates on multiple communication links, concurrently. In some instances, the peer MLDs 1011-1016 may be examples of one or both of the AP MLD 910 and the non-AP MLD 920 described with reference to FIG. 9. In various implementations, each of the peer MLDs 1011-1016 may include a first device associated with a first communication link of the mesh network 1000, and may include one or more second devices associated with one or more respective second communication links of the mesh network 1000. In some aspects, each of the multiple communication links may include one or more wireless channels in a respective frequency band of the 2.4 GHz frequency band, the 5 GHz frequency band, the 6 GHz frequency band, or the 60 GHz frequency band.

For example, although not shown in FIG. 10 for simplicity, the first device of a respective one of the peer MLDs 1011-1016 may include a first STA and a first AP, and each of the one or more second devices of the respective peer MLD may include a respective second STA and a respective second AP. In various aspects, each of the peer MLDs 1011-1016 may include or implement the AP MLD 910 described with reference to FIG. 9 on a first interface of the respective peer MLD, and may include or implement the non-AP MLD 920 described with reference to FIG. 9 on a second interface of the respective peer MLD. The first interface of a respective peer MLD may operate as an AP MLD with which one or more nearby peer MLDs 1011-1016 can associate and authenticate on multiple communication links (such as on the multi-link peering instances 1035), and the second interface of the respective peer MLD may operate as a non-AP MLD that can request association and authentication with other nearby peer MLDs 1011-1016. For example, in some instances, the first STA of a respective peer MLD may communicate with one or more previous-hop peer MLDs on the first communication link, and the first AP of the respective peer MLD may communicate with one or more next-hop peer MLDs on the first communication link. Each of the one or more second STAs of the respective peer MLD may communicate with the one or more previous-hop peer MLDs on the one or more respective second communication links, and each of the one or more second APs of the respective peer MLD may communicate with the one or more next-hop peer MLDs on the first communication link. In some other instances, the first STA of a respective peer MLD may communicate with one or more next-hop peer MLDs on the first communication link, and the first AP of the respective peer MLD may communicate with one or more previous-hop peer MLDs on the first communication link. Each of the one or more second STAs of the respective peer MLD may communicate with the one or more next-hop peer MLDs on the one or more respective second communication links, and each of the one or more second APs of the respective peer MLD may communicate with the one or more previous-hop peer MLDs on the first communication link.

In the example of FIG. 10, the first AP of peer MLD 1011 may operate a first basic service set (BSS1) on the first communication link, and may communicate with associated stations STAT and STA8 on the first communication link. The first AP of peer MLD 1012 may operate a second basic service set (BSS2) on the first communication link, and may communicate with associated stations STA4 and STA5 on the first communication link. The first AP of peer MLD 1013 may operate a third basic service set (BSS3) on the first communication link, and may be associated with stations STA1 and STA3. The first AP of peer MLD 1014 may operate a fourth basic service set (BSS4) on the first communication link, and may be associated with station STA6. The first AP of peer MLD 1015 may operate a fifth basic service set (BSS5) on the first communication link, and may be associated with stations STA9 and STA10. The first AP of peer MLD 1016 may operate a sixth basic service set (BSS6) on the first communication link, and may be associated with stations STA2 and STA11. Although not shown in FIG. 10 for simplicity, each of the one or more second APs of each of the peer MLDs 1011-1016 may operate a corresponding secondary BSS on a respective second communication link, and may communicate with one or more corresponding client devices on the respective second communication link.

The wireless networks associated with each of BSS1—BSS6 may be indicated to users by a corresponding service set identifier (SSID), and may be indicated to other devices by a basic service set identifier (BSSID), which may be the MAC address of the respective peer multi-link device. In some instances, each of peer MLDs 1011-1016 broadcasts beacon frames that include the BSSID of the respective BSS to enable STAs or other client devices within wireless range of the respective peer multi-link device to associate or re-associate with the respective peer multi-link device.

As discussed, aspects of the present disclosure recognize that multi-link operation may be enabled in a mesh network by replacing mesh protocol addresses carried in the medium access control (MAC) headers of mesh protocol frames with corresponding multi-link addresses based on per-link MAC addresses and MLD MAC addresses. In various implementations, each of the peer MLDs 1011-1016 may include 2-layer MAC addressing that includes a per-link MAC address identifying a corresponding communication link associated with the peer MLD, and an MLD MAC address identifying the peer MLD. In some instances, the per-link MAC address may indicate a receiver address or a transmitter addresses of a respective peering instance 1035, and the MLD MAC address may indicate a corresponding MBSS egress point or MBSS ingress point of a mesh path established in the mesh network 1000. Specifically, in some instances, the MAC headers of mesh protocol frames communicated over peering instances 1035 of the mesh network 1000 may be populated with multi-link protocol addresses that include first and second addresses indicating respective per-link receiver and per-link transmitter addresses of a peering instance 1035 on the first communication link, and include third and fourth addresses indicating respective MLD path destination and source addresses. In some aspects, the MAC headers of the mesh protocol frames also may include fifth and sixth addresses indicating MLD MAC addresses associated with a destination and a source, respectively.

In some implementations, each of the peer MLDs 1011-1016 that receives a mesh protocol frame from a previous-hop peer MLD or a next-hop peer MLD may replace the mesh protocol addresses in the MAC header of the mesh protocol frame with multi-link protocol addresses based on a mapping between mesh protocol addresses and multi-link protocol addresses. For example, in some instances, the mesh receiver and transmitter addresses carried in the Addr1 and Addr2 fields of the MAC header may be mapped to the per-link receiver and transmitter addresses, respectively, and the mesh STA destination and mesh STA source addresses carried in the Addr3 and Addr4 fields of the MAC header may be mapped to the MAC addresses of the peer MLDs associated with the mesh path destination and path source addresses, respectively. In some aspects, the destination and source addresses carried in the Addr5 and Addr6 fields of the MAC header may be mapped to the MAC addresses of the peer MLDs associated with the destination and source, respectively.

In various implementations, the peer MLDs 1011-1016 may learn the mappings between mesh protocol addresses and multi-link protocol addresses based on routing or forwarding addresses associated with frames received from previous-hop peer MLDs and next-hop peer MLDs. For example, when a respective peer MLD receives a mesh protocol frame from a previous-hop peer MLD or a next-hop peer MLD, the respective peer MLD may extract the mesh protocol addresses from the MAC header of the mesh protocol frame, and search the forwarding table associated with the respective peer MLD to find multi-link protocol addresses corresponding to the extracted mesh protocol addresses. Specifically, when the corresponding multi-link protocol addresses are stored in the forwarding table (based on the address mappings), the peer MLD replaces the mesh protocol addresses in the received mesh protocol frame with the corresponding multi-link protocol addresses retrieved from the forwarding table, and forwards the mesh protocol frame to one or more other peer MLDs based on the corresponding multi-link protocol addresses. Conversely, when the corresponding multi-link protocol addresses are not stored in the forwarding table, the peer MLD may determine or obtain the multi-link protocol addresses corresponding to the extracted mesh protocol addresses, and may create or modify the corresponding entry in the forwarding table with the determined or obtained multi-link protocol addresses. In this way, the respective peer MLD may implement MAC address mapping learning operations.

In some instances, a multi-link context associated with the mesh network 1000 may allow the peer MLDs 1011-1016 to discover, associate, and authenticate with one another on all of the communication links of the mesh network 1000 based on one or more of discovery information, capabilities, or operation parameters received or otherwise obtained on one of the communication links of the mesh network 1000. The multi-link context also may allow the peer MLDs 1011-1016 to establish a common security context, common encryption keys, common acknowledgement (BA) sessions, and Traffic Identifier (TID)-to-Link Mappings on all of the communication links based on frame exchanges on one of the communication links.

Specifically, in some implementations, one or more of the peer MLDs 1011-1016 may broadcast, on the first communication link, one or more mesh protocol frames that carry or indicate discovery information, capabilities, and operation parameters for each of the multiple communication links associated with the mesh network 1000. For example, in some instances, the mesh protocol frames may include a Multi-link element indicating discovery information for each of the communication links of the mesh network 1000. The Multi-link element also may indicate one or more MLD capabilities common to each of the communication links of the mesh network 1000. In some instances, the mesh protocol frames also may include a Reduced Neighbor Report (RNR) element indicating channel information, operation parameters, and MLD parameters of the one or more second APs associated with the one or more respective second communication links of the mesh network 1000. In some aspects, the mesh protocol frames also may include one or both of an EHT Capability element indicating one or more capabilities of the first device and the one or more second devices of a respective peer MLD or an EHT Operation element indicating one or more operation parameters for each of the first communication link and the one or more second communication links of the mesh network 1000. In some other instances, the mesh protocol frames also may include a TID-to-Link Mapping element indicating, for each of a plurality of TIDs, on which of the multiple communication links established between the peer MLDs 1011-1016 that mesh data frames belonging to the respective TID are permitted.

Each of the peer MLDs 1011-1016 that receives the broadcast mesh protocol frames on the first communication link may use one or more of the indicated discovery information, capabilities, or parameters to discover, associate, and authenticate with another peer MLD on all of the communication links associated with the mesh network 1000. In some instances, each of the peer MLDs 1011-1016 also may use one or more of the discovery information, capabilities, or parameters indicated by the broadcast mesh protocol frames to determine whether or not any of the discovered peer MLDs are suitable candidates with which to establish peering instances 1035 during path selection.

The value carried in the Link ID subfield of the per-STA Profile subelement carried in the Multi-link element of a mesh protocol frame transmitted by an AP of a respective peer MLD may be unique to each AP associated with the respective peer MLD. In some aspects, the link ID value assigned to a communication link by the AP of the respective peer MLD may be a representation of the tuple consisting of the Operating Class, the Operating channel, and the BSSID associated with the AP. When the peer MLDs 1011-1016 are configured to operate as mesh nodes within the mesh network 1000, a pair of the peer MLDs 1011-1016 may assign different Link IDs to the same communication link during multi-link setup operations, TID-to-Link mapping negotiations, and Target Wake Time (TWT) setup operations, among other examples.

For example, during a multi-link setup procedure to establish the peering instance 1035B between peer MLDs 1013 and 1014, the peer MLD 1013 may initiate TID-to-Link mapping negotiation by including a TID-to-Link Mapping element in an Association Request frame sent to the peer MLD 1014. The peer MLD 1014 may respond by sending, to the initiating peer MLD 1013, an Association Response frame including a TID-to-Link Mapping element indicating whether the proposed TID-to-link mappings are accepted, rejected, or modified. However, the TID-to-Link Mapping element carried in the Association Request frame may include a first Link ID selected by the initiating peer MLD 1013, and the TID-to-Link Mapping element carried in the Association Response frame may include a second Link ID selected by the responding peer MLD 1014. When the first and second Link IDs assigned by respective peer MLDs 1013 and 1014 are not the same, the peer MLDs 1013 and 1014 may not be able to successfully negotiate the TID-to-Link mappings.

Aspects of the subject matter disclosed herein recognize that while multi-link operations are unidirectional in an infrastructure BSS (such as because each MLD typically operates as either an AP MLD or a non-AP MLD), multi-link operations performed by peer MLDs 1011-1016 associated with the mesh network 1000 are bidirectional in that each of the peer MLDs 1011-1016 may operate as both an AP MLD and a non-AP MLD, concurrently. For example, when peer MLDs 1011-1016 use Mesh Peering Open and Mesh Peering Confirm frames to associate with one another or to establish peering instances 1035 between each other, the requesting peer MLD may assign a first Link ID to a respective peering instance 1035, and the responding peer MLD may assign a second Link ID to the respective peering instance 1035. The requesting peer MLD may include the first Link ID in Mesh Peering Open frames sent to the responding peer MLD, and the responding peer MLD may include the second Link ID in Mesh Peering Confirm frames sent to the requesting peer MLD. The conflicting Link IDs assigned by the requesting peer MLD and the responding peer MLD may preclude the successful completion of multi-link operations in the mesh network 1000.

Implementations of the subject matter disclosed herein may reconcile conflicting Link IDs assigned by different peer MLDs by indicating the mesh domain to which each assigned Link ID is referenced, and using the Link ID associated with the indicated mesh domain when requesting or establishing certain multi-link operations (such as TID-to-Link mapping negotiations, TWT setup operations, or r-TWT setup operations, among other examples) between peer MLDs over the established peering instances 1035. For example, in some instances, each peer MLD that requests a configured operation on a multi-link peering instance 1035 associated with a Link ID uses the Link ID assigned by the responding peer MLD. In some other instances, the responding peer MLD uses the Link ID assigned by the requesting peer MLD. In some other implementations, the peer MLDs associated with the requested configured operation may determine, negotiate, or otherwise agree on the Link ID to be used for the configured operation.

In some implementations, the peer MLDs 1011-1016 may discover one another and establish peering instances 1035 between one another based on the HWMP path selection procedure specified by the 802.11s amendments to the IEEE 802.11 standard. As discussed, the HWMP is a mesh path selection protocol that combines the flexibility of on-demand path selection with proactive topology tree extensions to select a path from a source device to a destination device along one or more nodes or “hops” in a mesh network. For example, in some instances, the source device may discover a multi-link path through the mesh network 1000 to the destination device by broadcasting PREQ messages to one or more of the peer MLDs 1011-1016 of the mesh network 1000. Each of the peer MLDs 1011-1016 that receives a PREQ message may forward the PREQ message to one or more downstream or “next-hop” peer MLDs closer to the destination device. When a PREQ message reaches the destination device, at least one path can be discovered between the source device and the destination device through the mesh network 1000.

The validity of a discovered path may be confirmed by propagating PREP messages along a reverse path from the destination device to the source device through the mesh network 1000. In some instances, the destination device may broadcast PREP messages to one or more of the peer MLDs 1011-1016 associated with the forward path extending from the source device to the destination device. Each of the peer MLDs 1011-1016 that receives or obtains a PREP message updates the forwarding information, link identifications, and link metrics in the respective MLD's forwarding table, and forwards the PREP message to one or more upstream or “previous-hop” peer MLDs that are closer to the source device. When one or more of the PREP messages reach the source device, the source device may verify the validity of the discovered path through the mesh network 1000.

In some implementations, the path discovery messages propagated through the mesh network 1000 during path selection procedures may carry or indicate one or more link metrics of the peering instances 1035 traversed by the respective messages. Specifically, in some instances, each of the peer MLDs 1011-1016 that receives a PREQ message updates the link metrics associated with the previous-hop peering instance 1035 with link metrics of the peering instance associated with the respective peer MLD, and stores the accumulated link metrics for each discovered path in the respective MLD's forwarding table. The accumulated link metrics can be used by the peer MLDs 1011-1016 to select candidate peer MLDs as intermediate mesh nodes along one or more discovered paths from the source device to the destination device. Along the reverse path, each of the peer MLDs 1011-1016 that propagates a PREP message may update the link metrics of the next-hop peering instance 1035 with link metrics of the peering instance associated with the respective peer MLD, and may store the accumulated link metrics associated with the reverse path in the respective MLD's forwarding table. In some aspects, the reverse path link metrics may be used by one or more of the peer MLDs 1011-1016 to transmit unicast PREP messages to the peer MLD associated with the source device.

In some implementations, the peer MLDs 1011-1016 may use the link metrics obtained during path discovery to select the most-suitable path between the source device and the destination device. In some instances, the most-suitable path may refer to one or more of the shortest path, the lowest cost path, or the path associated with the highest link quality. The peer MLDs 1011-1016 also may use the link metrics to improve network performance, for example, by selecting paths associated with low latencies and high throughput.

In the example of FIG. 10, the peer MLDs 1011-1016 discover a multi-link path from a source within or associated with STA1 to a destination within or associated with STA2. The multi-link path includes peering instances 1035A-1035E and passes through peer MLDs 1013-1016 of the mesh network 1000. In some implementations, the multi-link path may be discovered using the HWMP path selection protocol. For example, during path discovery, STA1 may broadcast, on the first communication link of the mesh network 1000, a Mesh Peering Open frame including a request to establish peering instances 1035 between various peer MLDs 1011-1016 on any one or more of the communication links of the mesh network 1000. In some aspects, the Mesh Peering Open frame may include one or more of a Multi-link element, a TID-to-Link Mapping element, an EHT Capability element, an EHT Operation element, or an RNR element. The Multi-link element may indicate discovery information for each of the communication links associated with the mesh network 1000, and may indicate MLD capabilities common to the one or more second communication links of the mesh network 1000. The TID-to-Link Mapping element may indicate which of the communication links of the mesh network 1000 are provisioned or allocated for traffic flows belonging to each of a plurality of TIDs. The EHT Capability element may indicate one or more capabilities of each of the first and one or more second devices of a respective peer MLD, and the EHT Operation element may indicate one or more operation parameters for each of the first and one or more second communication links of the mesh network 1000. The RNR element may indicate channel information, operation parameters, and MLD parameters of the one or more second communication links of the mesh network 1000.

Each of the peer MLDs 1011-1016 that receives the Mesh Peering Open frame may forward the Mesh Peering Open frame to one or more downstream peer MLDs, which in turn may forward the Mesh Peering Open frame to one or more other downstream peer MLDs closer to STA2, and so on, until at least one Mesh Peering Open frame reaches the destination at STA2. Each of the peer MLDs 1011-1016 that receives the Mesh Peering Open frame also may send a Mesh Peering Confirm frame to one or more upstream peer MLDs, which in turn may forward the Mesh Peering Confirm frame to one or more other peer MLDs closer to STA1, and so on, until at least one Mesh Peering Confirm frame reaches STA2. The Mesh Peering Confirm frame may indicate whether the requested peering instance is accepted or rejected by the respective peer MLD.

After the multi-link path from STA1 to STA2 through the mesh network 1000 is established, STA1 can send mesh protocol data frames or messages to STA2 using one or more of the multiple communication links associated with the mesh network 1000. For example, in some instances, STA1 obtains a payload from the source, encapsulates the payload in a mesh protocol data frame, and sends the mesh protocol data frame to peer MLD 1013 on the first communication link of peering instance 1035A for delivery to the destination within or associated with STA2. The MAC header of the mesh protocol data frame sent by STA1 may carry multi-link addresses that include per-link receiver and transmitter addresses, and MLD path source and destination addresses.

In the example of FIG. 10, STA1 is not associated with the mesh network 1000 or with the first STA of peer MLD 1013, and therefore the multi-link addresses carried in the mesh protocol data frame sent by STA1 use the four-address field 354 described with reference to FIG. 3. For example, in some aspects, the Addr1 field may carry or indicate the per-link address of peer MLD 1013, the Addr2 field may carry or indicate the per-link address of STA1, the Addr3 field may carry or indicate the MLD MAC address of STA2, and the Addr4 field may carry or indicate a null value.

The mesh protocol data frame is received by the first AP of peer MLD 1013 on the peering instance 1035A, and passed to the first STA of peer MLD 1013 for communication to the destination by peer MLDs 1014-1016 on respective peering instances 1035B-1035D. The first STA of peer MLD 1013 determines or obtains multi-link addresses indicating STA1 as the source device, indicating STA2 as the destination device, and indicating the peering instance 1035B and next-hop peer MLD 1014. In the example of FIG. 10, the peer MLD 1013 is located within and associated with the mesh network 1000, and therefore mesh protocol frames sent from the first STA of peer MLD 1013 use the six-address field 474 described with reference to FIG. 4. For example, in some aspects, the Addr1 field may carry or indicate the per-link address of peer MLD 1014, the Addr2 field may carry or indicate the per-link address of peer MLD 1014, the Addr3 field may carry or indicate the MLD MAC address of peer MLD 1016, the Addr4 field may carry or indicate the MLD MAC address of peer MLD 1013, the Addr5 field may carry or indicate the MLD MAC address of STA2, and the Addr6 field may carry or indicate the MLD MAC address of STA1.

The first STA of peer MLD 1013 forwards the mesh protocol data frame including the multi-link addresses to the next-hop peer MLD 1014 on the first communication link associated with peering instance 1035B. The first STA of peer MLD 1014 receives the mesh protocol data frame, and determines or obtains the multi-link addresses associated with the next-hop on peering instance 1035C based on, for example, on the mesh-to-MLD address mapping.

The first STA of peer MLD 1014 forwards the mesh protocol data frame including the multi-link addresses to the next-hop peer MLD 1015 on the first communication link associated with peering instance 1035C. The first STA of peer MLD 1015 receives the mesh protocol data frame, and determines or obtains the multi-link addresses associated with the next-hop peering instance 1035D based on the mesh-to-MLD address mapping.

The first STA of peer MLD 1015 forwards the mesh protocol data frame including the multi-link addresses to the next-hop peer MLD 1016 on the first communication link associated with peering instance 1035D. The mesh protocol data frame communicated on peering instance 1035D is received by the first STA of peer MLD 1016, and passed to the first AP of peer MLD 1016. The first AP of peer MLD 1016 determines or obtains the multi-link addresses associated with STA2 based on the mesh-to-MLD address mapping, and forwards the mesh protocol data frame including the multi-link addresses to STA2 on the first communication link associated with peering instance 1035E.

In the example of FIG. 10, STA2 is not associated with the mesh network 1000 or with the first STA of peer MLD 1016, and therefore the multi-link addresses carried in mesh protocol data frames sent to STA2 use the four-address field 354 described with reference to FIG. 3. For example, in some aspects, the Addr1 field may carry or indicate the per-link address of STA2, the Addr2 field may carry or indicate the per-link address of peer MLD 1016, the Addr3 field may carry or indicate the MLD MAC address of STA1, and the Addr4 field may carry or indicate a null value.

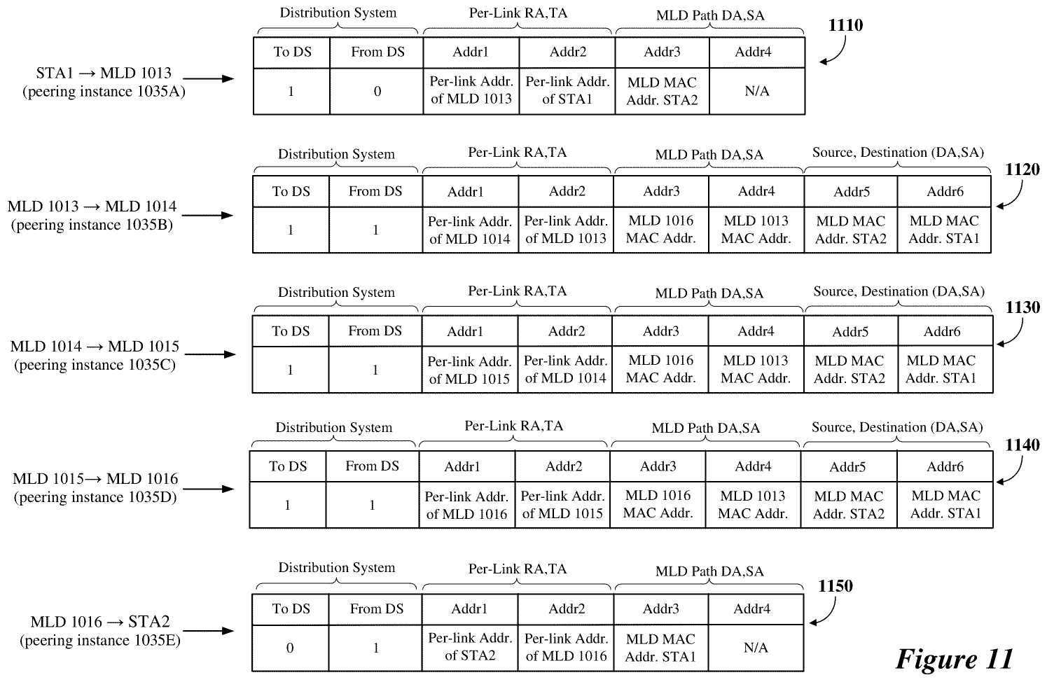

FIG. 11 shows example address fields 1110, 1120, 1130, 1140, and 1150 that may be used in the MAC headers of mesh protocol frames communicated from STA1 to STA2 over peering instances 1035A-1035E of the mesh network 1000 of FIG. 10. In the example of FIG. 11, each of the address fields 1110, 1120, 1130, 1140, and 1150 includes at least a Distribution System (DS) field and the four-address field described with reference to FIG. 4. The DS field includes a To DS address field and a From DS address field, and the four-address field includes an Addr1 field, an Addr2 field, an Addr3 field, and an Addr4 field. As discussed, the Addr1 field carries a per-link receiver address (RA) that may be mapped to the mesh STA receiver address, the Addr2 field carries a per-link transmitter address (TA) that may be mapped to the mesh STA transmitter address, the Addr3 field carries a path destination MLD MAC address that may be mapped to the mesh STA destination address (DA), and the Addr4 field carries a path source MLD MAC address that may be mapped to the mesh STA source address (SA). Each of the address fields 1120, 1130, and 1140 also includes an Addr5 field carrying a destination MLD MAC address that may be mapped to the mesh destination address (DA), and includes an Addr6 field carrying a source MLD MAC address that may be mapped to the mesh source address (SA).

In some implementations, the address field 1110 may be included in the MAC headers of mesh protocol frames sent from STA1 to peer MLD 1013 over peering instance 1035A of the mesh network 1000. Specifically, in some instances, the To DS address field carries a value of 1 to indicate that the mesh protocol frame is to be delivered to a destination that is not associated with the mesh network 1000, and the From DS address field carries a value of 0 to indicate that the mesh protocol frame is not received from a DS. The Addr1 field carries or indicates the per-link address of peer MLD 1013 (as the mesh RA), the Addr2 field carries or indicates the per-link address of STA1 (as the mesh TA), the Addr3 field carries or indicates the MLD MAC address of STA2 (as the destination), and the Addr4 field may indicate a null value.

The address field 1120 may be provided in the MAC headers of mesh protocol frames sent from peer MLD 1013 to peer MLD 1014 over peering instance 1035B. Specifically, in some instances, the To DS address field carries a value of 1 to indicate that the mesh protocol frame is to be delivered to a destination that is not associated with the mesh network 1000, and the From DS address field carries a value of 1 to indicate that the mesh protocol frame is received from a distribution system or gateway. The Addr1 field carries or indicates the per-link address of peer MLD 1014 (as the mesh RA), the Addr2 field carries or indicates the per-link address of peer MLD 1013 (as the mesh TA), the Addr3 field carries or indicates the MLD MAC address of peer MLD 1016 (as the mesh DA), the Addr4 field carries or indicates the MLD MAC address of peer MLD 1013 (as the mesh SA), the Addr5 field carries or indicates the MLD MAC address of STA2 (as the destination), and the Addr6 field carries or indicates the MLD MAC address of STA1 (as the source).

The address field 1130 may be provided in the MAC headers of mesh protocol frames sent from peer MLD 1014 to peer MLD 1015 over peering instance 1035C. The To DS and From DS address fields carry or indicate a value of 1, the Addr1 field carries or indicates the per-link address of peer MLD 1015 (as the mesh RA), the Addr2 field carries or indicates the per-link address of peer MLD 1014 (as the mesh TA), the Addr3 field carries or indicates the MLD MAC address of peer MLD 1016 (as the mesh DA), the Addr4 field carries or indicates the MLD MAC address of peer MLD 1013 (as the mesh SA), the Addr5 field carries or indicates the MLD MAC address of STA2 (as the destination), and the Addr6 field carries or indicates the MLD MAC address of STA1 (as the source).

The address field 1140 may be provided in the MAC header of mesh protocol frames sent from peer MLD 1015 to peer MLD 1016 over peering instances 1035D. The To DS and From DS address fields carry or indicate a value of 1, the Addr1 field carries or indicates the per-link address of peer MLD 1016 (as the mesh RA), the Addr2 field carries or indicates the per-link address of peer MLD 1015 (as the mesh TA), the Addr3 field carries or indicates the MLD MAC address of peer MLD 1016 (as the mesh DA), the Addr4 field carries or indicates the MLD MAC address of peer MLD 1013 (as the mesh SA), the Addr5 field carries or indicates the MLD MAC address of STA2 (as the destination), and the Addr6 field carries or indicates the MLD MAC address of STA1 (as the source).

The address field 1150 may be provided in the MAC header of mesh protocol frames sent from peer MLD 1016 to STA2. The To DS address field carries or indicates a value of 0, and the From DS address field carries or indicates a value of 1. The Addr1 field carries or indicates the per-link address of STA2 (as the mesh RA), the Addr2 field carries or indicates the per-link address of peer MLD 1016 (as the mesh TA), the Addr3 field carries or indicates the MLD MAC address of STA1 (as the mesh DA), and the Addr4 field carries or indicates a null value.

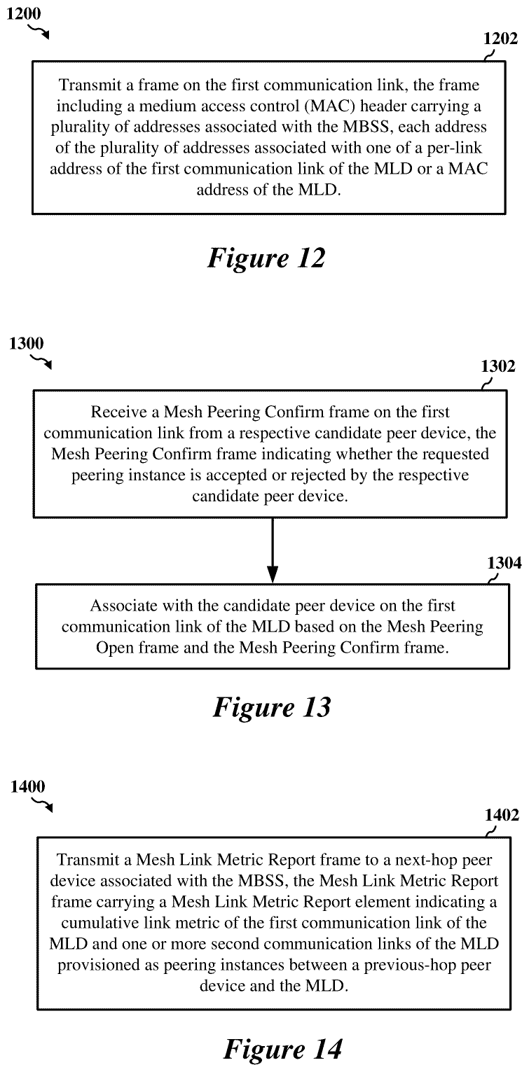

FIG. 12 shows a flowchart illustrating an example operation 1200 for wireless communication that supports multi-link operation in a mesh network. The operation 1200 may be performed by a wireless device such as one of the peer devices 132 of FIG. 1, the intermediate mesh nodes 231-233 of FIG. 2, the mesh nodes 311-312 of FIG. 3, the mesh nodes 421-424 of FIG. 4, the wireless communication device 700 of FIG. 7, the AP MLD 910 and the non-AP MLD 920 of FIG. 9, or the peer MLDs 1011-1016 described with reference to FIG. 10. In various aspects, the operation 1200 may be performed by an MLD configured to operate as a mesh device associated with a mesh basic service set (MBSS).

In some implementations, the operation 1200 may be performed by an MLD including a first device associated with a first communication link of the MLD and including one or more second devices associated with one or more respective second communication links of the MLD. In some instances, the first device may be associated with a first STA of the MLD and a first AP of the MLD. The first STA of the MLD may be configured to communicate with one of a previous-hop peer MLD or a next-hop peer MLD over the first communication link of the MLD, and the first AP of the MLD may be configured to communicate with the other of the previous-hop peer MLD or the next-hop peer MLD on the first communication link of the MLD. In some other instances, each of the one or more second devices of the MLD may be associated with a respective second STA of the MLD and a respective second AP of the MLD. The second STAs of the MLD may be configured to communicate with the one of the previous-hop peer MLD or the next-hop peer MLD over the one or more respective second communication links of the MLD, and each of the one or more second APs may be configured to communicate with the other of the previous-hop peer MLD or the next-hop peer MLD on the one or more respective second communication links of the MLD.

For example, at 1202, the MLD transmits a frame on the first communication link, the frame including a medium access control (MAC) header carrying a plurality of addresses associated with the MBSS, each address of the plurality of addresses associated with one of a per-link address of the first communication link or a MAC address of the MLD. In some instances, the plurality of addresses may include first and second addresses indicating respective receiver and transmitter addresses of a peering instance on the first communication link, and may include third and fourth addresses indicating respective MBSS egress and MBSS ingress points of the peering instance on the first communication link. The first and second addresses may be associated with per-link MAC addresses, and the third and fourth addresses may be associated with MLD MAC addresses. In some aspects, the plurality of addresses also may include fifth and sixth addresses indicating a destination and a source, respectively, of the peering instance, where each of the fifth and sixth addresses may be associated with MLD MAC addresses.

In some implementations, the frame may be one of a Hybrid Wireless Mesh Protocol (HWMP) Mesh Path Selection frame, a Mesh Peering Open frame, a Mesh Peering Confirm frame, a Mesh Peering Close frame, or a Mesh Data frame. In some instances, the frame may include a Multi-Link element indicating discovery information for the first communication link and discovery information for each of the one or more second communication links. In some other instances, the frame also may include a Traffic Identifier (TID)-to-Link Mapping element indicating, for each of a plurality of TIDs, on which of the first communication link or the one or more second communication links that mesh data frames belonging to the respective TID are permitted. In some other instances, the frame also may include one or both of an EHT Capability element indicating one or more capabilities of the first device of the MLD and one or more capabilities of the one or more second devices of the MLD, or an EHT Operation element indicating one or more operation parameters for the first communication link and one or more operation parameters for each of the one or more second communication links.

FIG. 13 shows a flowchart illustrating an example operation 1300 for wireless communication that supports multi-link operation in a mesh network. The operation 1300 may be performed by a wireless device such as one of the peer devices 132 of FIG. 1, the intermediate mesh nodes 231-233 of FIG. 2, the mesh nodes 311-312 of FIG. 3, the mesh nodes 421-424 of FIG. 4, the wireless communication device 700 of FIG. 7, the AP MLD 910 and the non-AP MLD 920 of FIG. 9, or the peer MLDs 1011-1016 described with reference to FIG. 10. In some instances, the operation 1300 may be performed by the MLD described with reference to FIG. 12.

In some aspects, the operation 1300 may be performed after transmission of a Mesh Peering Open frame on the first communication link at 1202 of FIG. 12. The Mesh Peering Open frame may include a request to establish peering instances on each of the first communication link and the one or more second communication links of the MLD. For example, at 1302, the MLD receives a Mesh Peering Confirm frame on the first communication link from a respective candidate peer device, the Mesh Peering Confirm frame indicating whether the requested peering instance is accepted or rejected by the respective candidate peer device. At 1304, the MLD associates with the candidate peer device on the first communication link based on the exchange of the Mesh Peering Open frame and the Mesh Peering Confirm frame.

FIG. 14 shows a flowchart illustrating an example operation 1400 for wireless communication that supports multi-link operation in a mesh network. The operation 1400 may be performed by a wireless device such as one of the peer devices 132 of FIG. 1, the intermediate mesh nodes 231-233 of FIG. 2, the mesh nodes 311-312 of FIG. 3, the mesh nodes 421-424 of FIG. 4, the wireless communication device 700 of FIG. 7, the AP MLD 910 and the non-AP MLD 920 of FIG. 9, or the peer MLDs 1011-1016 described with reference to FIG. 10. In some instances, the operation 1400 may be performed by the MLD described with reference to FIG. 12.

In some aspects, the operation 1400 may be performed after transmission of the frame at 1202 of FIG. 12. For example, at 1402, the MLD transmits a Mesh Link Metric Report frame to a next-hop peer device associated with the MBSS, the Mesh Link Metric Report frame carrying a Mesh Link Metric Report element indicating a cumulative link metric of each of the first communication link and the one or more second communication links of the MLD that are provisioned as peering instances between a previous-hop peer device and the MLD.

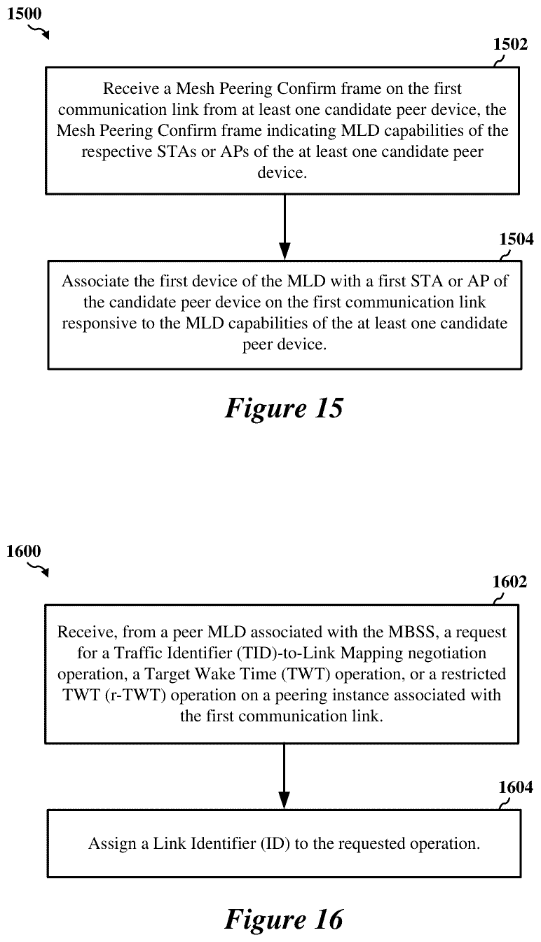

FIG. 15 shows a flowchart illustrating an example operation 1500 for wireless communication that supports multi-link operation in a mesh network. The operation 1500 may be performed by a wireless device such as one of the peer devices 132 of FIG. 1, the intermediate mesh nodes 231-233 of FIG. 2, the mesh nodes 311-312 of FIG. 3, the mesh nodes 421-424 of FIG. 4, the wireless communication device 700 of FIG. 7, the AP MLD 910 and the non-AP MLD 920 of FIG. 9, or the peer MLDs 1011-1016 described with reference to FIG. 10. In some instances, the operation 1500 may be performed by the MLD described with reference to FIG. 12.

In some aspects, the operation 1500 may be performed after transmission of a Mesh Peering Open frame on the first communication link at 1202 of FIG. 12. The Mesh Peering Open frame may indicate the MLD capabilities of each of the first device and the one or more second devices of the MLD. For example, at 1502, the MLD receives a Mesh Peering Confirm frame on the first communication link from at least one candidate peer device including a respective station (STA) or access point (AP) associated with each of the first communication link and the one or more second communication links of the MLD, the Mesh Peering Confirm frame indicating MLD capabilities of the respective STAs or APs of the at least one candidate peer device. At 1504, the MLD associates the first device of the MLD with a first STA or AP of the candidate peer device on the first communication link responsive to the MLD capabilities of the at least one candidate peer device.

FIG. 16 shows a flowchart illustrating an example operation 1600 for wireless communication that supports multi-link operation in a mesh network. The operation 1600 may be performed by a wireless device such as one of the peer devices 132 of FIG. 1, the intermediate mesh nodes 231-233 of FIG. 2, the mesh nodes 311-312 of FIG. 3, the mesh nodes 421-424 of FIG. 4, the wireless communication device 700 of FIG. 7, the AP MLD 910 and the non-AP MLD 920 of FIG. 9, or the peer MLDs 1011-1016 described with reference to FIG. 10. In some implementations, the operation 1600 may be performed by the MLD described with reference to FIG. 12.

In some instances, the operation 1600 may be performed in conjunction with the operation 1200 of FIG. 12. In some other instances, the operation 1600 may be performed after transmission of the frame at 1202 of FIG. 12. For example, at 1602, the MLD receives, from a peer MLD associated with the MBSS, a request for a Traffic Identifier (TID)-to-Link Mapping negotiation operation, a Target Wake Time (TWT) operation, or a restricted TWT (r-TWT) operation on a peering instance associated with the first communication link. At 1604, the MLD assigns a Link Identifier (ID) to the requested operation. In some implementations, the assignment of the Link ID to the requested operation may be associated with one of the Link ID assigned to the peering instance by the MLD, the Link ID assigned to the peering instance by the peer MLD, or an agreement or negotiation between the MLD and the peer MLD indicating one of the Link ID assigned to the peering instance by the MLD or the Link ID assigned to the peering instance by the peer MLD.

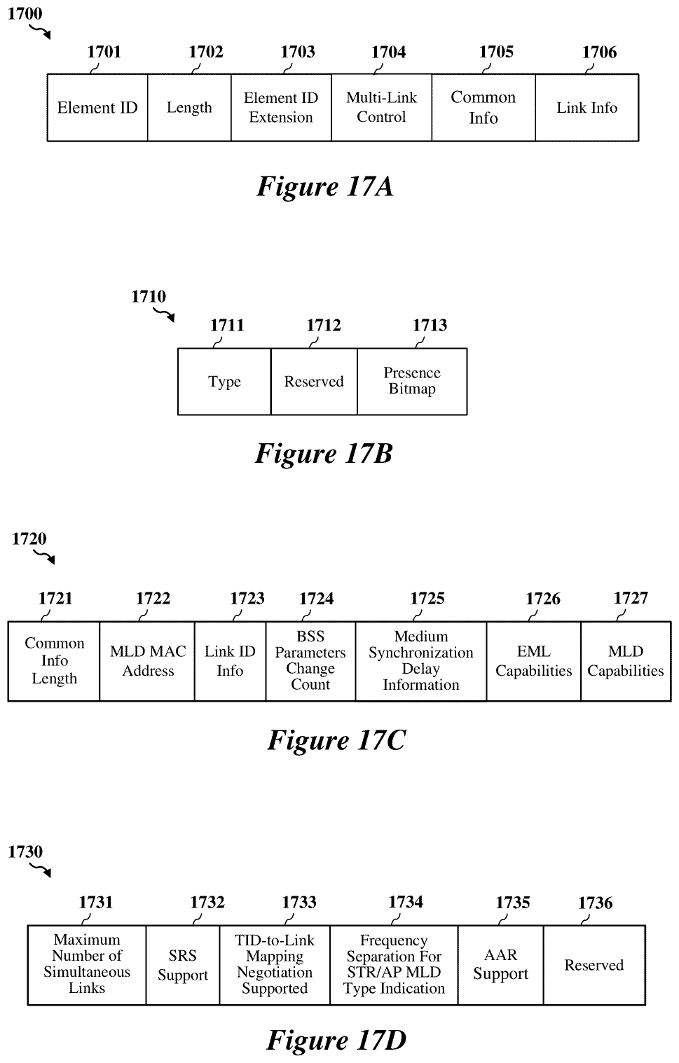

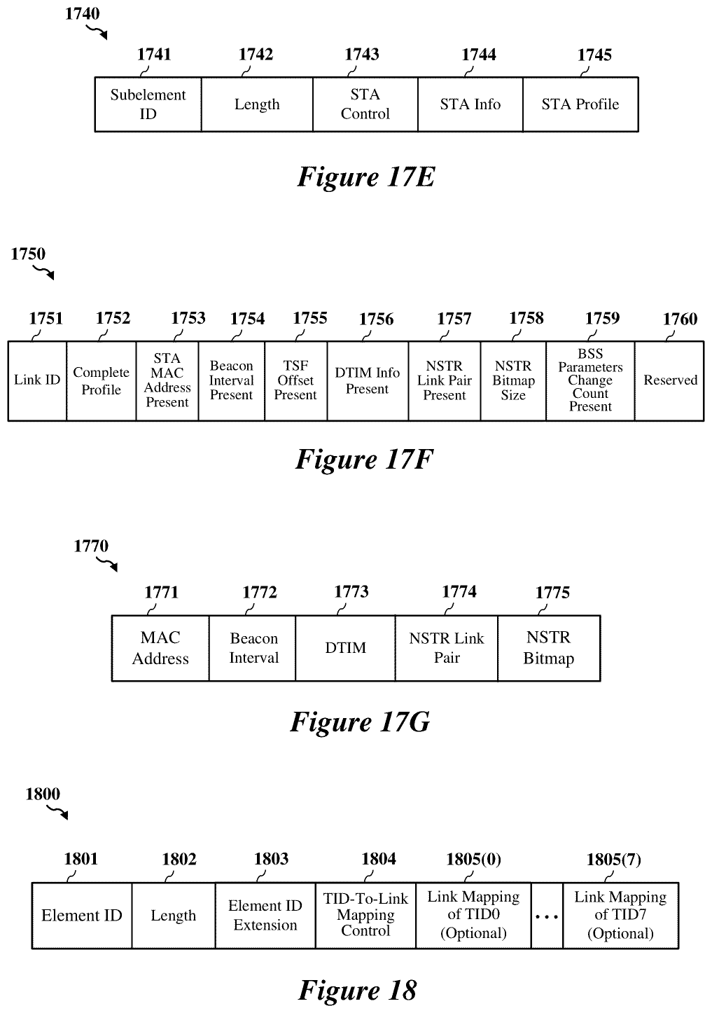

FIG. 17A shows an example Multi-link element 1700 that can be used to support multi-link operation in a mesh network. In some instances, the Multi-link element 1700 may be included in WLAN management frames such as (but not limited to) a Beacon frame, Probe Request frame, a Probe Response frame, an Association Request frame, an Association Response frame, a Re-association Request frame, or a Re-association Response frame. In some aspects, the Multi-link element 1700 also may be included in mesh protocol frames such as (but not limited to) HWMP Mesh Path Selection frames, Mesh Peering Open frames, Mesh Peering Confirm frames, Mesh Peering Close frames, or Mesh Data frames.

The Multi-link element 1700 includes an Element ID field 1701, a Length field 1702, an Element ID Extension field 1703, a Multi-Link Control field 1704, a Common Info field 1705, and a Link Info field 1706. The Element ID field 1701 and the Element ID Extension field 1703 carry values indicating that the element is a Multi-link element and indicating the type of Multi-link element. The Length field 1702 carries a value indicating the length of the Multi-link element 1700. The Multi-Link Control field 1704 carries information indicating the presence of various fields and subfields in the Common Info field 1705. The Common Info field 1705 carries information common to one or more non-primary links associated with an AP MLD. The Link Info field 1706 carries information specific to each of the non-primary links associated with the AP MLD. In some instances, the Link Info field 1706 includes one or more Per-STA Profile subelements that carry or indicate the complete or partial profiles of one or more corresponding non-primary links of an AP MLD.

FIG. 17B shows an example Multi-Link Control field 1710 that can be used to support multi-link operation in a mesh network. In some instances, the Multi-Link Control field 1710 may be an example of the Multi-Link Control field 1704 of the Multi-link element 1700 of FIG. 17A. As shown, the Multi-Link Control field 1710 includes a Type field 1711, a reserved field 1712, and a Presence Bitmap field 1713. The Type field 1711 is used to differentiate between variants of the Multi-link Element 1700 (such as a Basic Multi-link element and a Probe Request Multi-link element). The reserved field 1712 includes one or more reserved or unused bits. The Presence Bitmap field 1713 is used to indicate the presence of various subfields in the Common Info field 1705 of the Multi-link element 1700. For example, the Presence Bitmap field 1713 may indicate the presence of an MLD MAC address field, a Link ID Info field, a BSS Parameters Change Count field, a Medium Synchronization Delay Information field, an enhanced Multi-Link (EML) Capabilities field, and an MLD Capabilities field in the Common Info field 1705 of the Multi-link element 1700.

FIG. 17C shows an example Common Info field 1720 that can be used to support multi-link operation in a mesh network. In some instances, the Common Info field 1720 may be an example of the Common Info field 1705 of the Multi-link element 1700 of FIG. 17A. As shown, the Common Info field 1720 includes a Common Info Length subfield 1721, an MLD MAC Address subfield 1722, a Link ID Info subfield 1723, a BSS Parameters Change Count subfield 1724, a Medium Synchronization Delay Information subfield 1725, an EML Capabilities subfield 1726, and an MLD Capabilities subfield 1727. The Common Info Length subfield 1721 indicates the number of octets in the Common Info field 1720. The MLD MAC Address subfield 1722 carries the MAC address of the MLD. The Link ID Info subfield 1723 carries the link identifier of the AP that transmits the Multi-link element 1700. The BSS Parameters Change Count subfield 1724 carries an unsigned integer, initialized to 0, that increments when a critical update occurs to the operational parameters for the AP that transmits the Basic variant Multi-link element.

In some instances, the MLD MAC Address subfield 1722 may carry or indicate the MAC address of a peer MLD described with reference to FIG. 10, and the Link ID Info subfield 1723 may carry or indicate the MAC address of a corresponding peering instance 1035 described with reference to FIG. 10.

The Medium Synchronization Delay Information subfield 1725 carries a value indicating the duration of the MediumSyncDelay timer. The EML Capabilities subfield 1726 contains a number of subfields that are used to advertise the capabilities for EML Single-Radio (SR) operation and EML Multiple-Radio (MR) operation. The MLD Capabilities subfield 1727 indicates various capabilities of the MLD. For example, the MLD Capabilities subfield 1727 may indicate the maximum number of links that support the simultaneous transmission or reception of frames, whether the MLD supports the reception of frames that carry an SRS control subfield, whether the MLD supports TID-to-Link mapping negotiation, and the minimum frequency gap between any two links that is recommended by the non-AP MLD for STR operation.

FIG. 17D shows an example MLD Capabilities subfield 1730 that can be used to support multi-link operation in a mesh network. In some instances, the MLD Capabilities subfield 1730 may be an example of the MLD Capabilities subfield 1730 of the Common Info field 1720 of FIG. 17C. As shown, the MLD Capabilities subfield 1730 includes a Maximum Number of Simultaneous Links subfield 1731, an SRS subfield 1732, a TID-to-Link Mapping Negotiation Supported subfield 1733, a Frequency Separation for STR/AP MLD Type Indication subfield 1734, an AAR Support subfield 1735, and a Reserved subfield 1736. The Maximum Number of Simultaneous Links subfield 1731 indicates the maximum number of STAs affiliated with the MLD that support simultaneous transmission or reception of frames on the respective links. The SRS subfield 1732 indicates support for the reception of a frame that carries an SRS Control subfield. The TID-to-Link Mapping Negotiation Supported subfield 1733 indicates support for TID-to-link mapping negotiation. The Frequency Separation for STR/AP MLD Type Indication subfield 1734 indicates the minimum frequency gap between any two links that is recommended by the non-AP MLD for STR operation. The AAR Support subfield 1735 indicates support for receiving a frame with an AAR Control subfield.

FIG. 17E shows an example Per-STA Profile subelement 1740 that can be used to support multi-link operation in a mesh network. In some instances, the Per-STA Profile subelement 1740 may be an example of the Per-STA Profile subelements carried in the Link Info field 1706 of the Multi-link element 1700 of FIG. 17A. As shown, the Per-STA Profile subelement 1740 may include a Subelement ID field 1741, a Length field 1742, a STA Control field 1743, a STA Info field 1744, and a STA Profile field 1745. The Subelement ID field 1741 carries a value indicating the type of the Per-STA Profile subelement 1740. The Length field 1742 carries a value indicating the length of the Per-STA Profile subelement 1740. The STA Control field 1743 carries information indicating the presence (or absence) of various fields and subfields in the STA Profile field 1745. The STA Info field 1744 carries information pertaining to the AP corresponding to the Per-STA Profile subelement 1740. The STA Profile field 1745 carries information indicating the complete or partial profile of the AP corresponding to the Per-STA Profile subelement 1740.

FIG. 17F shows an example STA Control field 1750 that can be used to support multi-link operation in a mesh network. In some instances, the STA Control field 1750 may be an example of the STA Control field 1743 of the Per-STA Profile subelement 1740 of FIG. 17E. As shown, the STA Control field 1750 includes a Link ID subfield 1751, a Complete Profile subfield 1752, a STA MAC Address Present subfield 1753, a Beacon Interval Present subfield 1754, a TSF Offset Present subfield 1755, a DTIM Info Present subfield 1756, an NSTR Link Pair Present subfield 1757, an NSTR Bitmap Size subfield 1758, a BSS Parameters Change Count Present subfield 1759, and a Reserved subfield 1760. The Link ID subfield 1751 carries a value that uniquely identifies the communication link associated with the AP corresponding to the Per-STA Profile subelement 1740. The Complete Profile subfield 1752 carries a value indicating whether the Per-STA Profile subelement 1740 carries the complete profile or a partial profile of the corresponding AP.

The STA MAC Address Present subfield 1753 indicates the presence of the STA MAC Address subfield in the STA Info field 1744 of the Multi-link element 1700, and is set to 1 if the STA MAC Address subfield is present in the STA Info field, otherwise the STA MAC Address Present subfield 1753 is set to 0. A STA sets the STA MAC Address Present subfield 1753 to 1 when the Multi-link element 1700 carries the complete profile of a corresponding communication link.

The Beacon Interval Present subfield 1754 indicates the presence of the Beacon Interval subfield in the STA Info field 1744 and is set to 1 if the Beacon Interval subfield is present in the STA Info field 1744, otherwise the Beacon Interval Present subfield 1754 is set to 0. A non-AP STA sets the Beacon Interval Present subfield to 0 in the transmitted Basic Multi-Link element. An AP sets the Beacon Interval Present subfield 1754 to 1 when the Multi-link element 1700 carries the complete profile of a corresponding communication link. An AP affiliated with an NSTR mobile AP MLD and that is operating on nonprimary links sets the Beacon Interval Present subfield 1754 to 0.

The TSF Offset Present subfield 1755 indicates the presence of the TSF Offset subfield in the STA Info field 1744 and is set to 1 if the TSF Offset subfield is present in the STA Info field, otherwise the TSF Offset Present subfield 1755 is set to 0. A non-AP STA sets the TSF Offset Present subfield to 0 in the transmitted Basic Multi-Link element. An AP sets the TSF Offset Present subfield 1755 to 1 when the Multi-link element 1700 carries the complete profile of a corresponding communication link.

The DTIM Info Present subfield 1756 indicates the presence of the DTIM Info subfield in the STA Info field 1744 and is set to 1 if the DTIM Info subfield is present in the STA Info field 1744, otherwise the DTIM Info Present subfield 1756 is set to 0. A non-AP STA sets the DTIM Info Present subfield to 0 in the transmitted Basic Multi-Link element. An AP sets the DTIM Info Present subfield 1756 to 1 when the Multi-link element 1700 carries the complete profile of a corresponding communication link. An AP affiliated with an NSTR mobile AP MLD and that is operating on the nonprimary link set the DTIM Info Present subfield 1756 to 0.

The NSTR Link Pair Present subfield 1757 carries a value indicating whether the Per-STA Profile subelement 1740 carries information pertaining to a pair of communication links associated with an NSTR softAP MLD. The NSTR Bitmap Size subfield 1758 carries a value indicating the size of an NSTR Indication Bitmap field included in the Per-STA Profile subelement 1740 of FIG. 17E.

The BSS Parameters Change Count Present subfield 1759 indicates the presence of the BSS Parameters Change Count subfield in the STA Info field and is set to 1 if the BSS Parameters Change Count subfield is present in the STA Info field, otherwise the BSS Parameters Change Count Present subfield 1759 is set to 0. A non-AP STA sets the BSS Parameters Change Count Present subfield to 0 in the transmitted Basic Multi-Link element. If the Basic Multi-Link element carries the complete profile and is carried in the (Re)Association Response frame, an AP sets the BSS Parameters Change Count Present subfield 1759 to 1. Otherwise, an AP sets the BSS Parameters Change Count Present subfield 1759 to 0.

FIG. 17G shows an example STA Info field 1770 that can be used to support multi-link operation in a mesh network. In some instances, the STA Info field 1770 may be an example of the STA Info field 1744 of the Per-STA Profile subelement 1740 of FIG. 17E. As shown, the STA Info field 1770 includes a MAC Address field 1771, a Beacon Interval field 1772, a DTIM field 1773, an NSTR Link Pair field 1774, and an NSTR Bitmap field 1775. The MAC Address field 1771 carries the MAC address of the AP corresponding to the Per-STA Profile subelement 1740. The Beacon Interval field 1772 carries information indicating the beacon interval of the AP corresponding to the Per-STA Profile subelement 1740. The DTIM field 1773 carries information indicating the DTIM count and the DTIM period of the AP corresponding to the Per-STA Profile subelement 1740. The NSTR Link Pair field 1774 carries information identifying the pair of communication links associated with the AP corresponding to the Per-STA Profile subelement 1740. The NSTR Bitmap field 1775 carries an NSTR bitmap of the AP corresponding to the Per-STA Profile subelement 1740.

FIG. 18 shows an example Traffic Identifier (TID)-to-Link Mapping element 1800 usable for multi-link operation in a mesh network. As shown, the TID-to-Link Mapping element 1800 may include an Element ID field 1801, a Length field 1802, an Element ID Extension field 1803, a TID-to-Link Mapping Control field 1804, and one or more optional Link Mapping of TID fields 1805(0)-1805(7). The Element ID field 1801 and the Element ID Extension field 1803 carry values indicating that the element 1800 is a TID-to-Link Mapping element and indicating the type of TID-to-Link Mapping element. The Length field 1802 indicates a length (in octets) of the TID-to-Link Mapping element 1800.

The TID-to-Link Mapping Control field 1804 may include a Direction subfield and a Default Link Mapping subfield (not shown for simplicity). For example, the Direction subfield is set to 0 if the TID-To-link Mapping element 1800 provides the TID-to-link mapping information for frames transmitted on the downlink, the Direction subfield is set to 1 if the TID-To-Link Mapping element 1800 provides the TID-to-link mapping information for frames transmitted on the uplink, and the Direction subfield is set to 2 if the TID-To-Link Mapping element 1800 provides the TID-to-link mapping information for frames transmitted both on the downlink and the uplink. The Default Link Mapping subfield is set to 1 if the TID-To-Link Mapping element represents the default TID-to-link mapping, and is otherwise set to 0.

Each of the Link Mapping of TID fields 1805(0)-1805(7) indicates the link or links on which frames belonging to a respective TID are allowed to be sent. In some instances, each of the Link Mapping of TID fields 1805(0)-1805(7) carries a bitmap of the links to which the respective TID is mapped to. For example, a value of 1 in bit position i (where i=0, 1, 2, . . . , 14) indicates that the respective TID is mapped to the link associated with the link ID i for the direction specified in the Direction subfield, and a value of 0 in bit position i indicates that the respective TID is not mapped to the link associated with the link ID i.

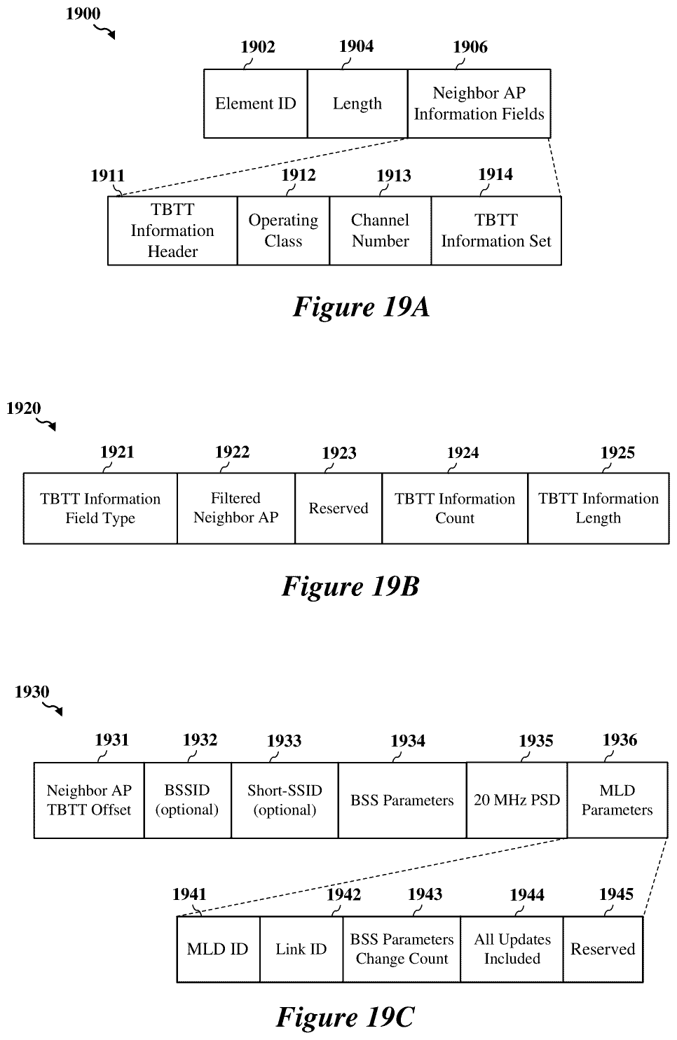

FIG. 19A shows an example RNR element 1900 that can be used to support multi-link operation in a mesh network. In some instances, the RNR element 1900 may be included in WLAN management frames such as (but not limited to) a Beacon frame, Probe Request frame, a Probe Response frame, an Association Request frame, an Association Response frame, a Re-association Request frame, or a Re-association Response frame. In some other instances, the RNR element 1900 may be included in mesh protocol frames such as (but not limited to) an HWMP Mesh Path Selection frame, a Mesh Peering Open frame, a Mesh Peering Confirm frame, a Mesh Peering Close frame, or a Mesh Data frame.

The RNR element 1900 may be used to indicate channel information, parameters, and other information related to the one or more second APs associated with the one or more second communication links of the peer MLDs described with reference to FIG. 10. As shown, the RNR element 1900 includes an Element ID field 1902, a Length field 1904, and one or more Neighbor AP Information fields 1906. The Element ID field 1902 carries a value identifying the RNR element 1900. The Length field 1904 carries a value indicating the length of the RNR element 1900. Each Neighbor AP Information field 1906 carries information indicating timing references, the operating class, the channel number, and other parameters of a corresponding second AP of the peer MLD.

The Neighbor AP Information field 1906 includes a TBTT Information header 1911, an Operating Class field 1912, a Channel Number field 1913, and a TB TT Information Set field 1914. The TBTT Information header 1911 carries general information pertaining to the corresponding AP. The Operating Class field 1912 indicates a channel starting frequency that, together with the Channel Number field 1913, indicates the primary channel of the BSS of the AP associated with the Neighbor AP Information field. The Channel Number field 1913 indicates the last known primary channel of the AP associated with the Neighbor AP Information field. The TBTT Information Set field 1914 contains one or more TBTT Information fields that carry TBTT information, operation parameters, and MLD parameters for the AP associated with the Neighbor AP Information field.

FIG. 19B shows an example TBTT Information Header 1920 that can be used to support multi-link operation in a mesh network. In some instances, the TBTT Information Header 1920 may be an example of the TBTT Information Header 1911 of FIG. 19A. As shown, the TBTT Information Header 1920 includes a TBTT Information Field Type subfield 1921, a Filtered Neighbor AP subfield 1922, a reserved subfield 1923, a TBTT Information Count subfield 1924, and a TBTT Information Length subfield 1925. The TBTT Information Field Type subfield 1921 carries a value indicating the type or format of the TBTT Information field.

The Filtered Neighbor AP subfield 1922 is reserved except when the Reduced Neighbor Report element 1900 is carried in a Probe Response frame transmitted by an EHT AP. The reserved subfield 1923 includes one or more reserved or unused bits. The TBTT Information Count subfield 1924 indicates the number of TBTT Information fields included in the TBTT Information Set field 1914 of the Neighbor AP Information field 1906, minus one. The TBTT Information Length subfield 1925 indicates the length of each TB TT Information field included in the TBTT Information Set field of the Neighbor AP Information field.

FIG. 19C shows an example TBTT Information field 1930 that can be used to support multi-link operation in a mesh network. In some instances, the TBTT Information field 1930 may be an example of the TBTT Information field(s) carried in the TBTT Information Set field 1914 of FIG. 19A. As shown, the TBTT Information field 1930 includes a Neighbor AP TBTT Offset subfield 1931, an optional BSSID subfield 1932, an optional Short-SSID subfield 1933, a BSS Parameters subfield 1934, a 20 MHz PSD subfield 1935, and an MLD Parameters subfield 1936. The Neighbor AP TBTT Offset subfield 1931 indicates the offset (in TUs) of the next TBTT of the reported AP from the immediately prior TBTT of the reporting AP. The optional BSSID subfield 1932 carries the BSSID of the reported AP. The optional Short-SSID subfield 1933 carries the shortened SSID of the reported AP. The BSS Parameters subfield 1934 indicates one or more BSS parameters of the reported AP such as (but not limited to) an OCT Recommended subfield, a same SSID subfield, a multiple BSSID subfield, a Transmitted BSSID subfield, a ESS Member subfield, an Unsolicited Probe Responses Active subfield, and a Co-Located AP subfield. The 20 MHz PSD subfield 1935 indicates a maximum transmit power for the corresponding AP on a primary 20 MHz channel. In some instances, the Neighbor AP TBTT Offset subfield 1931, the Short-SSID subfield 1933, the BSS Parameters subfield 1934, and 20 MHz PSD subfield 1935 may be omitted from the TBTT Information field 1930.

The MLD Parameters subfield 1936 may include an MLD ID subfield 1941, a Link ID subfield 1942, a BSS Parameters Change Count subfield 1943, and a Reserved subfield 1944. The MLD ID subfield 1941 indicates the identifier of the AP MLD with which the reported AP is affiliated. If the reported AP is affiliated with the same MLD as the reporting AP sending the frame carrying the RNR element, the MLD ID subfield 1941 is set to 0. If the reported AP is affiliated with the same MLD as a non-transmitted BSSID that is in the same multiple BSSID set as the reporting AP sending the frame carrying the RNR element, the MLD ID subfield 1941 is set to the same value as in the BSSID Index field in the Multiple BSSID-Index element in the non-transmitted BSSID profile corresponding to the non-transmitted BSSID.

The Link ID subfield 1942 indicates the link identifier of the reported AP within the AP MLD with which the reported AP is affiliated. The Link ID subfield is set to 15 if the reported AP is not part of an AP MLD, or if the reporting AP does not have that information.

The BSS Parameters Change Count subfield 1943 is an unsigned integer, initialized to 0, that increments when a critical update to the Beacon frame of the reported AP occurs. The BSS Parameters Change Count subfield 1943 is set to 255 if the reported AP is not part of an AP MLD, or if the reporting AP does not have information pertaining to the critical updates.

The All Updates Included subfield 1944 indicates if the updated elements corresponding to the latest critical update that generated a change to the value carried in the BSS Parameters Change Count subfield for the AP are included in the frame carrying the RNR element 1900. The All Updates Included subfield 1944 is set to 1 if all of the updated elements are included, and is otherwise set to 0. The Reserved subfield 1945 includes one or more reserved or unused bits.

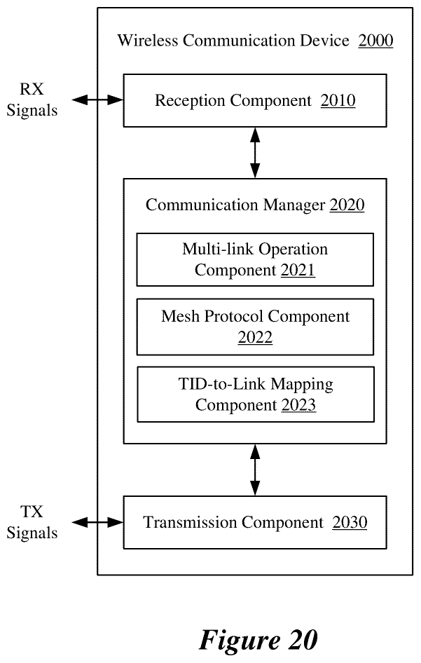

FIG. 20 shows a block diagram of an example wireless communication device 2000. In some implementations, the wireless communication device 2000 may be configured to perform the operations 1200, 1300, 1400, and 1500 described with reference to FIGS. 12, 13, 14, and 15, respectively. The wireless communication device 2000 can be an example implementation of any of the peer devices 132 of FIG. 1, the intermediate mesh nodes 231-233 of FIG. 2, the mesh nodes 311-312 of FIG. 3, the mesh nodes 421-424 of FIG. 4, the wireless communication device 700 of FIG. 7, the MLDs 910 and 920 of FIG. 9, or the peer MLDs described with reference to FIG. 10. More specifically, the wireless communication device 2000 can be a chip, SoC, chipset, package or device that includes at least one processor and at least one modem (for example, a Wi-Fi (IEEE 802.11) modem or a cellular modem).

The wireless communication device 2000 includes a reception component 2010, a communication manager 2020, and a transmission component 2030. The communication manager 2020 includes a Multi-link Operation component 2021, a Mesh Protocol component 2022, and a TID-to-Link Mapping component 2023. Portions of one or more of the components 2021-2023 may be implemented at least in part in hardware or firmware. In some implementations, one or more of the components 2021-2023 are implemented at least in part as software stored in a memory (such as the memory 708 of FIG. 7). For example, portions of one or more of the components 2021-2023 can be implemented as non-transitory instructions (or “code”) executable by a processor (such as the processor 706 of FIG. 7) to perform the functions or operations of the respective component.

The reception component 2010 is configured to receive RX signals from one or more other wireless communication devices, and the transmission component 2030 is configured to transmit TX signals to one or more other wireless communication devices. The communication manager 2020 is configured to manage wireless communications with one or more other wireless communication devices.

The Multi-link Operation component 2021 may establish or setup multi-link operation on the peering instances or mesh links associated with a mesh network. In some instances, the Multi-link Operation component 2021 also may map the mesh addresses carried in the MAC header of mesh protocol frames or messages to one of a per-link address of a corresponding peering instance or a MAC address of a corresponding MLD.

The Mesh Protocol component 2022 may discover peer devices associated with a mesh network and within radio range of the wireless communication device 2000, and may determine whether any of the discovered peer devices are candidates suitable for establishing a peering instance or mesh link. In some instances, the Mesh Protocol component 2022 also may establish peering instances or mesh links in the mesh network with the suitable candidate peer devices. In some other instances, the Mesh Protocol component 2022 also may discover paths between a source device and a destination device over one or more of the established peering instances or mesh links. In some aspects, the Mesh Protocol component 2022 may employ HWMP path selections techniques described herein to establish peering instances or mesh links, and to discover the best-suited path from the source device to the destination device.

The TID-to-Link Mapping component 2023 may determine or obtain mappings between the TIDs of traffic flows associated with a respective device and the communication links of a MLD provisioned or allocated to the respective device. In some instances, the TID-to-Link Mapping component 2023 also may update the mappings based on changes in the communication links provisioned or allocated to the respective device.

Implementation examples are described in the following example aspects:
1. A multi-link device (MLD), including:
   a processing system; and
   an interface coupled to the processing system, the interface configured to:
      output a frame on a first communication link associated with a first device of the MLD, the frame including a medium access control (MAC) header carrying a plurality of addresses associated with a mesh basis service set (MBSS), each address of the plurality of addresses associated with one of a per-link address of the first communication link of the MLD or a MAC address of the MLD.
2. The MLD of aspect 1, where the frame includes an indication that the per-link address is based on a domain of the MLD.
3. The MLD of any one or more of aspects 1-2, where the plurality of addresses includes:
first and second addresses indicating respective receiver and transmitter addresses of a peering instance on the first communication link, the first and second addresses associated with the per-link address of the first communication link; and
third and fourth addresses indicating respective MBSS egress and MBSS ingress points of the peering instance on the first communication link, the third and fourth addresses associated with the MLD MAC address.
4. The MLD of aspect 3, where the plurality of addresses further includes:
fifth and sixth addresses indicating a respective destination and a source of the peering instance, the fifth and sixth addresses associated with the MLD MAC address.
5. The MLD of any one or more of aspects 1-4, where the frame includes one of a Hybrid Wireless Mesh Protocol (HWMP) Mesh Path Selection frame, a Mesh Peering Open frame, a Mesh Peering Confirm frame, a Mesh Peering Close frame, or a Mesh Data frame.
6. The MLD of aspect 5, where the frame includes a Multi-Link element indicating discovery information for the first communication link of the MLD and discovery information for one or more second communication links associated with one or more respective second devices of the MLD.
7. The MLD of any one or more of aspects 5-6, where the frame carries a Traffic Identification (TID)-to-Link Mapping element indicating, for each TID of a plurality of TIDs, on which of the communication links associated with the MLD that mesh data frames belonging to the respective TID are permitted.
8. The MLD of any one or more of aspects 5-7, where the frame includes one or both of:
an Extremely High Throughput (EHT) Capability element indicating one or more capabilities of the first device of the MLD and one or more capabilities of each of one or more second devices of the MLD; or
an EHT Operation element indicating one or more operation parameters for the first communication link of the MLD and one or more operation parameters for each of one or more second communication links associated with the one or more respective second devices of the MLD.

9. The MLD of any one or more of aspects 1-8, where the frame includes a Mesh Peering Open frame outputted over the first communication link of the MLD to one or more candidate peer devices associated with the MBSS, the Mesh Peering Open frame including a request to establish peering instances on each of the first communication link of the MLD and one or more second communication links associated with one or more respective second devices of the MLD.
10. The MLD of aspect 9, where:
the interface is further configured to obtain a Mesh Peering Confirm frame on the first communication link from a respective candidate peer device, the Mesh Peering Confirm frame indicating whether the requested peering instance is accepted or rejected by the respective candidate peer device; and
the processing system is further configured to associate with the candidate peer device on the first communication link of the MLD based on the Mesh Peering Open frame and the Mesh Peering Confirm frame.
11. The MLD of aspect 9, where the Mesh Peering Open frame indicates MLD capabilities of the first device and the one or more second devices of the MLD, and where:
the interface further configured to obtain a Mesh Peering Confirm frame on the first communication link from at least one candidate peer device including a respective station (STA) or access point (AP) associated with each of the first communication link of the MLD and the one or more second communication links of the MLD, the Mesh Peering Confirm frame indicating MLD capabilities of the respective STAs or APs of the at least one candidate peer device; and
the processing system is further configured to associate the first device of the MLD with a first STA or AP of the at least one candidate peer device on the first communication link responsive to the MLD capabilities of the at least one candidate peer device while associating the one or more second devices of the MLD with one or more respective second STAs or APs of the at least one candidate peer device on the one or more respective second communication links.
12. The MLD of any one or more of aspects 1-11, where the interface is further configured to:
output a Mesh Link Metric Report frame to a next-hop peer device associated with the MBSS, the Mesh Link Metric Report frame carrying a Mesh Link Metric Report element indicating a cumulative link metric of the first communication link and one or more second communication links of the MLD provisioned as peering instances between a previous-hop peer device associated with the MBSS and the MLD.
13. The MLD of aspect 12, where:
the interface is associated with a first station (STA) of the MLD and a first access point (AP) of the MLD, the first STA of the MLD configured to communicate with the next-hop peer device over the first communication link of the MLD, the first AP of the MLD configured to communicate with the previous-hop peer device over the first communication link of the MLD; and
the interface is further associated with one or more second STAs of the MLD and one or more second APs of the MLD, the one or more second STAs of the MLD configured to communicate with the next-hop peer device over the one or more respective second communication links of the MLD, each of the one or more second APs of the MLD configured to communicate with the previous-hop peer device over the one or more respective second communication links of the MLD.
14. The MLD of any one or more of aspects 12-14, where the cumulative link metric is associated with one of:
data rates associated with the communication links provisioned as peering instances; or
latencies associated with the communication links provisioned as peering instances.
15. The MLD of any one or more of aspects 12-15, where the Mesh Link Metric Report element further includes one or more link metrics for all communication links of the MLD provisioned as peering instances between a mesh path source and a mesh path destination.
16. The MLD of any one or more of aspects 1-16, where:
the interface is further configured to obtain, from a peer MLD associated with the MBSS, a request for a Traffic Identifier (TID)-to-Link Mapping negotiation operation, a Target Wake Time (TWT) operation, or a restricted TWT (r-TWT) operation on a peering instance associated with the first communication link; and
the processing system is further configured to assign a Link Identifier (ID) to the requested operation.
17. The MLD of aspect 16, where the assignment of the Link ID to the requested operation is associated with one of:
the Link ID assigned to the peering instance by the MLD;
the Link ID assigned to the peering instance by the peer MLD; or
an agreement or negotiation between the MLD and the peer MLD indicating one of the Link ID assigned to the peering instance by the MLD or the Link ID assigned to the peering instance by the peer MLD.
18. A method for wireless communication by a multi-link device (MLD), including:
transmitting a frame on a first communication link associated with a first device of the MLD, the frame including a medium access control (MAC) header carrying a plurality of addresses associated with a mesh basis service set (MBSS), each address of the plurality of addresses associated with one of a per-link address of the first communication link of the MLD or a MAC address of the MLD.
19. The method of aspect 18, where the plurality of addresses includes:
first and second addresses indicating respective receiver and transmitter addresses of a peering instance on the first communication link, the first and second addresses associated with the per-link address of the first communication link; and
third and fourth addresses indicating respective MBSS egress and MBSS ingress points of the peering instance on the first communication link, the third and fourth addresses associated with the MLD MAC address.
20. The method of aspect 19, where the plurality of addresses further includes:
fifth and sixth addresses indicating a respective destination and a source of the peering instance, the fifth and sixth addresses associated with the MLD MAC address.
21. The method of any one or more of aspects 18-20, where the frame includes one of a Hybrid Wireless Mesh Protocol (HWMP) Mesh Path Selection frame, a Mesh Peering Open frame, a Mesh Peering Confirm frame, a Mesh Peering Close frame, or a Mesh Data frame.
22. The method of aspect 21, where the frame includes a Multi-Link element indicating discovery information for the first communication link of the MLD and discovery information for each of one or more second communication links associated with one or more respective second devices of the MLD.
23. The method of any one or more of aspects 20-21, where the frame carries a Traffic Identification (TID)-to-Link Mapping element indicating, for each TID of a plurality of TIDs, on which of the communication links associated with the MLD that mesh data frames belonging to the respective TID are permitted.
24. The method of any one or more of aspects 20-23, where the frame includes one or both of:
an Extremely High Throughput (EHT) Capability element indicating one or more capabilities of the first device of the MLD and one or more capabilities of each of one or more second devices of the MLD; or
an EHT Operation element indicating one or more operation parameters for the first communication link of the MLD and one or more operation parameters for each of one or more second communication links associated with the one or more respective second devices of the MLD.
25. The method of any one or more of aspects 18-24, where the frame includes a Mesh Peering Open frame transmitted over the first communication link to one or more candidate peer devices associated with the MBSS, the Mesh Peering Open frame including a request to establish peering instances on each of the first communication link of the MLD and one or more second communication links associated with one or more respective second devices of the MLD.
26. The method of aspect 25, further including:
receiving a Mesh Peering Confirm frame on the first communication link from a respective candidate peer device, the Mesh Peering Confirm frame indicating whether the requested peering instance is accepted or rejected by the respective candidate peer device; and
associating with the candidate peer device on the first communication link of the MLD based on the Mesh Peering Open frame and the Mesh Peering Confirm frame.
27. The method of any one or more of aspects 25-26, where the Mesh Peering Open frame indicates MLD capabilities of the first device and the one or more second devices of the MLD, the method further including:
receiving a Mesh Peering Confirm frame on the first communication link from at least one candidate peer device including a respective station (STA) or access point (AP) associated with each of the first communication link of the MLD and the one or more second communication links of the MLD, the Mesh Peering Confirm frame indicating MLD capabilities of the respective STAs or APs of the at least one candidate peer device; and
associating the first device of the MLD with a first STA or AP of the at least one candidate peer device on the first communication link responsive to the MLD capabilities of the at least one candidate peer device while associating the one or more second devices of the MLD with one or more respective second STAs or APs of the at least one candidate peer device on the one or more respective second communication links.
28. The method of any one or more of aspects 18-27, further including:
transmitting a Mesh Link Metric Report frame to a next-hop peer device associated with the MBSS, the Mesh Link Metric Report frame carrying a Mesh Link Metric Report element indicating a cumulative link metric of the first communication link of the MLD and one or more second communication links of the MLD provisioned as peering instances between a previous-hop peer device associated with the MBSS and the MLD.
29. The method of any one or more of aspects 18-29, further including:
receiving, from a peer MLD associated with the MBSS, a request for a Traffic Identifier (TID)-to-Link Mapping negotiation operation, a Target Wake Time (TWT) operation, or a restricted TWT (r-TWT) operation on a peering instance associated with the first communication link; and
assigning a Link Identifier (ID) to the requested operation.
30. The method of aspect 29, where the assignment of the Link ID to the requested operation is associated with one of:
the Link ID assigned to the peering instance by the MLD;
the Link ID assigned to the peering instance by the peer MLD; or
an agreement or negotiation between the MLD and the peer MLD indicating one of the Link ID assigned to the peering instance by the MLD or the Link ID assigned to the peering instance by the peer MLD.
31. An apparatus for wireless communications, including means for performing a method according to any one or more of aspects 18-30.
32. A non-transitory computer-readable storage medium storing instructions that, when executed by a processing system of an apparatus, cause the apparatus to perform operations according to any one or more of aspects 18-30.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c. As used herein, “based on” is intended to be interpreted in the inclusive sense, unless otherwise explicitly indicated. For example, “based on” may be used interchangeably with “based at least in part on,” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described herein. Whether such functionality is implemented in hardware, firmware or software depends upon the particular application and design constraints imposed on the overall system.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described herein as acting in particular combinations, and even initially claimed as such, one or more features from a claimed combination can In some instances be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described herein should not be understood as requiring such separation in all implementations, and it should be understood that the described program components and systems can generally be integrated together in a single software product or packaged into multiple software products.

What is claimed is:

1. A multi-link device (MLD), comprising:
a processing system; and
an interface coupled to the processing system, the interface configured to:
output a frame on a first communication link associated with a first device of the MLD, the frame including a medium access control (MAC) header carrying a plurality of addresses associated with a mesh basis service set (MBSS), each address of the plurality of addresses associated with one of a per-link address of the first communication link of the MLD or a MAC address of the MLD.

2. The MLD of claim 1, wherein the frame includes an indication that the per-link address is based on a domain of the first MLD.

3. The MLD of claim 1, wherein the plurality of addresses includes:
first and second addresses indicating respective receiver and transmitter addresses of a peering instance on the first communication link, the first and second addresses associated with the per-link address of the first communication link; and
third and fourth addresses indicating respective MBSS egress and MBSS ingress points of the peering instance on the first communication link, the third and fourth addresses associated with the MLD MAC address.

4. The MLD of claim 3, wherein the plurality of addresses further includes:
fifth and sixth addresses indicating a respective destination and a source of the peering instance, the fifth and sixth addresses associated with the MLD MAC address.

5. The MLD of claim 1, wherein the frame comprises one of a Hybrid Wireless Mesh Protocol (HWMP) Mesh Path Selection frame, a Mesh Peering Open frame, a Mesh Peering Confirm frame, a Mesh Peering Close frame, or a Mesh Data frame.

6. The MLD of claim 5, wherein the frame includes a Multi-Link element indicating discovery information for the first communication link of the MLD and discovery information for one or more second communication links associated with one or more respective second devices of the MLD.

7. The MLD of claim 5, wherein the frame carries a Traffic Identification (TID)-to-Link Mapping element indicating, for each TID of a plurality of TIDs, on which of the communication links associated with the MLD that mesh data frames belonging to the respective TID are permitted.

8. The MLD of claim 5, wherein the frame includes one or both of:
an Extremely High Throughput (EHT) Capability element indicating one or more capabilities of the first device of the MLD and one or more capabilities of each of one or more second devices of the MLD; or
an EHT Operation element indicating one or more operation parameters for the first communication link of the MLD and one or more operation parameters for each of one or more second communication links associated with the one or more respective second devices of the MLD.

9. The MLD of claim 1, wherein the frame comprises a Mesh Peering Open frame outputted over the first communication link of the MLD to one or more candidate peer devices associated with the MBSS, the Mesh Peering Open frame including a request to establish peering instances on each of the first communication link of the MLD and one or more second communication links associated with one or more respective second devices of the MLD.

10. The MLD of claim 9, wherein:
the interface is further configured to obtain a Mesh Peering Confirm frame on the first communication link from a respective candidate peer device, the Mesh Peering Confirm frame indicating whether the requested peering instance is accepted or rejected by the respective candidate peer device; and
the processing system is further configured to associate with the candidate peer device on the first communication link of the MLD based on the Mesh Peering Open frame and the Mesh Peering Confirm frame.

11. The MLD of claim 9, wherein the Mesh Peering Open frame indicates MLD capabilities of the first device and the one or more second devices of the MLD, wherein:
the interface is further configured to obtain a Mesh Peering Confirm frame on the first communication link from at least one candidate peer device including a respective station (STA) or access point (AP) associated with each of the first communication link of the MLD and the one or more second communication links of the MLD, the Mesh Peering Confirm frame indicating MLD capabilities of the respective STAs or APs of the at least one candidate peer device; and
the processing system is further configured to associate the first device of the MLD with a first STA or AP of the at least one candidate peer device on the first communication link responsive to the MLD capabilities of the at least one candidate peer device while associating the one or more second devices of the MLD with one or more respective second STAs or APs of the at least one candidate peer device on the one or more respective second communication links.

12. The MLD of claim 1, wherein the interface is further configured to:
output a Mesh Link Metric Report frame to a next-hop peer device associated with the MBSS, the Mesh Link Metric Report frame carrying a Mesh Link Metric Report element indicating a cumulative link metric of the first communication link and one or more second communication links of the MLD provisioned as peering instances between a previous-hop peer device associated with the MBSS and the MLD.

13. The MLD of claim 12, wherein:
the interface is associated with a first station (STA) of the MLD and a first access point (AP) of the MLD, the first STA of the MLD configured to communicate with the next-hop peer device over the first communication link of the MLD, the first AP of the MLD configured to communicate with the previous-hop peer device over the first communication link of the MLD; and
the interface is further associated with one or more second STAs of the MLD and one or more second APs of the MLD, the one or more second STAs of the MLD configured to communicate with the next-hop peer device over the one or more respective second communication links of the MLD, each of the one or more second APs of the MLD configured to communicate with the previous-hop peer device over the one or more respective second communication links of the MLD.

14. The MLD of claim 12, wherein the cumulative link metric is associated with one of:
data rates associated with the communication links provisioned as peering instances; or
latencies associated with the communication links provisioned as peering instances.

15. The MLD of claim 12, wherein the Mesh Link Metric Report element further includes one or more link metrics for all communication links of the MLD provisioned as peering instances between a mesh path source and a mesh path destination.

16. The MLD of claim 1, wherein:
the interface is further configured to obtain, from a peer MLD associated with the MBSS, a request for a Traffic Identifier (TID)-to-Link Mapping negotiation operation, a Target Wake Time (TWT) operation, or a restricted TWT (r-TWT) operation on a peering instance associated with the first communication link; and
the processing system is further configured to assign a Link Identifier (ID) to the requested operation.

17. The MLD of claim 16, wherein the assignment of the Link ID to the requested operation is associated with one of:
the Link ID assigned to the peering instance by the MLD;
the Link ID assigned to the peering instance by the peer MLD; or
an agreement or negotiation between the MLD and the peer MLD indicating one of the Link ID assigned to the peering instance by the MLD or the Link ID assigned to the peering instance by the peer MLD.

18. A method for wireless communication by a multi-link device (MLD), comprising:
transmitting a frame on a first communication link associated with a first device of the MLD, the frame including a medium access control (MAC) header carrying a plurality of addresses associated with a mesh basis service set (MBSS), each address of the plurality of addresses associated with one of a per-link address of the first communication link of the MLD or a MAC address of the MLD.

19. The method of claim 18, wherein the plurality of addresses includes:
first and second addresses indicating respective receiver and transmitter addresses of a peering instance on the first communication link, the first and second addresses associated with the per-link address of the first communication link; and
third and fourth addresses indicating respective MBSS egress and MBSS ingress points of the peering instance on the first communication link, the third and fourth addresses associated with the MLD MAC address.

20. The method of claim 19, wherein the plurality of addresses further includes:
fifth and sixth addresses indicating a respective destination and a source of the peering instance, the fifth and sixth addresses associated with the MLD MAC address.

21. The method of claim 18, wherein the frame comprises one of a Hybrid Wireless Mesh Protocol (HWMP) Mesh Path Selection frame, a Mesh Peering Open frame, a Mesh Peering Confirm frame, a Mesh Peering Close frame, or a Mesh Data frame.

22. The method of claim 21, wherein the frame includes a Multi-Link element indicating discovery information for the first communication link of the MLD and discovery information for each of one or more second communication links associated with one or more respective second devices of the MLD.

23. The method of claim 21, wherein the frame carries a Traffic Identification (TID)-to-Link Mapping element indicating, for each TID of a plurality of TIDs, on which of the communication links associated with the MLD that mesh data frames belonging to the respective TID are permitted.

24. The method of claim 21, wherein the frame includes one or both of:
an Extremely High Throughput (EHT) Capability element indicating one or more capabilities of the first device of the MLD and one or more capabilities of each of one or more second devices of the MLD; or
an EHT Operation element indicating one or more operation parameters for the first communication link of the MLD and one or more operation parameters for each of one or more second communication links associated with the one or more respective second devices of the MLD.

25. The method of claim 18, wherein the frame comprises a Mesh Peering Open frame transmitted over the first communication link to one or more candidate peer devices associated with the MBSS, the Mesh Peering Open frame including a request to establish peering instances on each of the first communication link of the MLD and one or more second communication links associated with one or more respective second devices of the MLD.

26. The method of claim 25, further comprising:
receiving a Mesh Peering Confirm frame on the first communication link from a respective candidate peer device, the Mesh Peering Confirm frame indicating whether the requested peering instance is accepted or rejected by the respective candidate peer device; and
associating with the candidate peer device on the first communication link of the MLD based on the Mesh Peering Open frame and the Mesh Peering Confirm frame.

27. The method of claim 25, wherein the Mesh Peering Open frame indicates MLD capabilities of the first device and the one or more second devices of the MLD, the method further comprising:
receiving a Mesh Peering Confirm frame on the first communication link from at least one candidate peer device including a respective station (STA) or access point (AP) associated with each of the first communication link of the MLD and the one or more second communication links of the MLD, the Mesh Peering Confirm frame indicating MLD capabilities of the respective STAs or APs of the at least one candidate peer device; and
associating the first device of the MLD with a first STA or AP of the at least one candidate peer device on the first communication link responsive to the MLD capabilities of the at least one candidate peer device while associating the one or more second devices of the MLD with one or more respective second STAs or APs of the at least one candidate peer device on the one or more respective second communication links.

28. The method of claim 18, further comprising:
transmitting a Mesh Link Metric Report frame to a next-hop peer device associated with the MBSS, the Mesh Link Metric Report frame carrying a Mesh Link Metric Report element indicating a cumulative link metric of the first communication link of the MLD and one or more second communication links of the MLD provisioned as peering instances between a previous-hop peer device associated with the MBSS and the MLD.

29. The method of claim 18, further comprising:
receiving, from a peer MLD associated with the MBSS, a request for a Traffic Identifier (TID)-to-Link Mapping negotiation operation, a Target Wake Time (TWT) operation, or a restricted TWT (r-TWT) operation on a peering instance associated with the first communication link; and
assigning a Link Identifier (ID) to the requested operation.

30. The method of claim 29, wherein the assignment of the Link ID to the requested operation is associated with one of:
the Link ID assigned to the peering instance by the MLD;
the Link ID assigned to the peering instance by the peer MLD; or
an agreement or negotiation between the MLD and the peer MLD indicating one of the Link ID assigned to the peering instance by the MLD or the Link ID assigned to the peering instance by the peer MLD.
